(19) United States
(12) Patent Application Publication
(10) Pub. No.: US 2025/0021658 A1
(43) Pub. Date: Jan. 16, 2025

(54) SYSTEMS AND METHODS FOR PREDICTING SECURITY COMMUNICATIONS BASED ON SEQUENCES OF SYSTEM ACTIVITY TOKENS

(71) Applicant: Capital One Services, LLC, McLean, VA (US)

(72) Inventors: Samuel SHARPE, Cambridge, MA (US); Christopher Bayan BRUSS, Washington, DC (US); Senthil KUMAR, Marlboro, NJ (US)

(73) Assignee: Capital One Services, LLC, McLean, VA (US)

(21) Appl. No.: 18/351,465

(22) Filed: Jul. 12, 2023

(51) Int. Cl. G06F 21/57

(52) U.S. Cl. CPC G06F 21/577

(57) ABSTRACT

Systems and methods for generating communications based on user account activity data are described herein. For example, the system may receive an input activity log and generate a plurality of tokens. The system may generate a time-ordered sequence of tokens based on the plurality of tokens. The system may generate an output vector encoding based on a machine learning model. The system may generate a predicted communication based on a vector encoding model. The system may transmit the predicted communication to a user device.

### BACKGROUND

As information, data, and other digital resources continue to be produced, stored, and exchanged, so does the need persist to implement data management that is able to handle security concerns pre-emptively and proactively. For example, the amount of secure information stored within data centers has increased, with more and more sensitive information being exchanged between users, authenticators, and data storage entities. For example, biometric information or personal identifiable information may be collected, stored, and transmitted to various entities, such as in servers managed by medical providers or authentication services (e.g., for user identification, including at international border crossings and/or authentication terminals). Because such information is liable to be stolen and/or misused, conventionally, any loss of control of such sensitive information by an owner of such data may lead to disastrous consequences, including identity theft, false authentication, and loss of data. As such, data storage systems may benefit from improved security breach monitoring, such that any data breach events may be contained or managed more efficiently and effectively.

### SUMMARY

Accordingly, methods and systems are described herein for predicting user communications associated with, for example, security breaches related to user accounts based on activity data. For example, the system may receive information relating to user activities associated with a data storage system account. The system may predict a communication or message that the user may send the system, such as a communication from the user indicating suspicion of a data breach within the data storage account. Thus, the system enables monitoring of user activity to detect security breaches before a user of such a data storage account detects such a breach, thereby improving the efficiency and efficacy of the data storage system's security and breach management.

Existing systems may rely on users, independent investigators, and/or detection algorithms that are able to detect security breaches. For example, conventional systems may determine that a security breach has likely occurred by evaluating user account history for adherence to criteria or rules. As an illustrative example, a conventional system may detect an internet protocol (IP) address or location associated with user activity, such as data downloads or uploads. Based on this change in IP address or location, an existing system may flag this behavior as unexpected and, as such, a potential security breach. However, such conventional systems fail to account for larger scale patterns in user activity over time, which may influence whether a user's account may be associated with a breach. For example, in some cases, a security breach, such as a virus afflicting a data center, may transfer or upload sensitive information associated with a user account over time in small portions, which may be missed by a breach detection algorithm. In some cases, a user account may be afflicted by multiple types of security breaches (e.g., associated with multiple malicious entities over time) that are dependent on each other (e.g., a first breach that enables access to further portions of a user's account in a subsequent breach). A conventional, algorithmic detection system may miss these more complicated, time-dependent breach events, thereby leading to further security breaches and/or difficulties in mitigating any prior or current breach events. Furthermore, a detection system detects security breaches without context from users, such as information relating to how users may have determined the breach, as well as any concerns that the users have regarding the breach.

To overcome these deficiencies in conventional systems, methods and systems disclosed herein enable translation between sequences of tokens that represent activities and communications, based on leveraging machine learning models, such as vector encoding models and/or contrastive learning models (e.g., contrastive machine learning models), in order to link user communications with corresponding user activities.

For example, in some implementations, the system may predict users' concerns regarding security breaches within a data storage center. As an illustrative example, a user may utilize a data storage center for storage of secure information or privileged data. The data storage system may record information relating to an account within the system, such as any uploads, downloads, or file access events. The system may store such information in the form of an activity log, such that information relating to the account's usage may be tracked and analyzed over time. In some instances, a user of an account may suspect a security breach. For example, the user may detect unrecognized files or missing files within the account. Accordingly, a user may generate a message describing the potential security breach and relay the message (e.g., a communication) to a system administrator for further investigation. The methods and systems disclosed enable analysis of the activity log to predict user communications about account security in a way that improves detection times for security breaches, such that the security breaches may be detected sooner. Furthermore, the system enables description of any detected security breaches in easy-to-understand words of the user, thereby summarizing any suspected security breaches and simplifying investigation and security breach mitigation by investigators.

In some implementations, the system may generate a time-ordered sequence of tokens that represent activities associated with a user. For example, the system may represent each activity associated with the user account (e.g., a file upload, download, or access event) using a token that describes the nature of the activity. Uploads of files larger than a certain size may be represented by a particular alphanumeric sequence of characters. These tokens may be organized in order of when the activity occurred, as this order may provide contextual information regarding the nature of any associated security breaches within the data storage system. The system may utilize a machine learning model to generate an output vector encoding that represents a predicted communication that may be associated with the time-ordered sequence of tokens. The predicted communication may include a predicted email message, call transcript, or instant message in natural language regarding a possible security breach if, for example, the activity log indicates or is associated with a security breach (e.g., an unauthorized upload, download, or access of files). Thus, the system enables translation of sequences of user activities into predicted user communications, in a manner that retains information regarding the sequence and temporal structure of the activities. Accordingly, the methods and systems disclosed herein enable investigators to predict security breach-related communications by users prior to communications by the users themselves, thereby improving user-related, contextual information relating to security breaches and enabling faster detection of security breach events.

In some aspects, the system may receive an input activity log that includes activities associated with a user. For example, the system may receive, for a user account, an input activity log that includes a list of user activities. Each user activity in the list of user activities may have a corresponding activity timestamp. In some implementations, the system may receive an activity log that includes information regarding downloads, uploads, and transfers of files from a user's account, such as a list of such activities, values of the file sizes, and a timestamp for the initiation of the corresponding user activity. By doing so, the system may collect information that may be material to determining the presence of security breaches (e.g., through processing associated user communications).

The system may generate a plurality of tokens corresponding to the input activity log based on a set of criteria. For example, the system may generate a plurality of tokens based on a set of criteria, where each token in the plurality of tokens includes a corresponding alphanumeric identifier that represents a corresponding activity class for a corresponding user activity of the list of user activities. Each corresponding alphanumeric identifier may be determined based on one or more activity class rules. The one or more activity class rules may indicate rules for classifying user activities into corresponding activity classes. For example, the system may generate a list of alphanumeric identifiers (e.g., tokens) that correspond to the received input activity log. The alphanumeric identifiers may be determined based on rules (e.g., as associated with the set of criteria) for classifying a given activity in the activity log. As an illustrative example, the system may determine that an activity of the activity list that corresponds to downloading a file with a size of less than 5 megabytes (MB) is associated with a particular token, which may be generated within the plurality of tokens accordingly. By doing so, the system provides a system-wide representation of activity log data corresponding to a given user to enable training and predictions based on such activities.

The system may generate a time-ordered sequence of tokens, based on the plurality of tokens. Each token in the time-ordered sequence of tokens may be ordered based on the corresponding activity timestamp associated with the corresponding user activity for each token. As an illustrative example, the system may re-order the plurality of tokens that were generated based on the list of activities in order of timestamp (e.g., when the activity occurred). By doing so, the system may encode the order of activities that may have been performed in relation to the user account, as the order of activities performed may be material to the presence of a security breach. For example, tokens that are associated with earlier downloads or uploads may be represented higher up in the list of activities than tokens that are associated with more recent downloads or uploads. Furthermore, a communication associated with the user (e.g., complaining about a possible security breach) may refer to or be dependent on an order of activities performed. Thus, by encoding the order of activities within the activity log, the system enables retention of information that is helpful for the detection or investigation of security breaches.

The system may input the time-ordered sequence of tokens into a machine learning model to generate an output vector encoding. For example, based on inputting the time-ordered sequence of tokens into a machine learning model, the system may generate an output vector encoding, such that the output vector encoding represents syntax and lexicon for a predicted communication based on the input activity log. For example, the system may generate a vector representation of the time-ordered sequence that corresponds to a predicted communication, where the vector representation is in a vector space that is able to capture the syntax and lexicon of words, phrases, and/or verbal communications, such as through a natural language processing model, such as word2vec or doc2vec, thereby preserving information that includes meaning and contextual information relating to the user account activity. By doing so, the system enables prediction of communications based on sequences of activities for breach detection or investigation purposes.

The system may then generate the predicted communication based on inputting the output vector encoding into a vector encoding model. For example, the system may input the output vector encoding into a natural language processing model, such as word2vec or doc2vec, that enables conversion of the vector encoding into natural language. Thus, the system may output text, audio, or another representation of a user interaction (e.g., an email, chat, or phone call) that is predicted to be associated with the input activity log. By doing so, the system enables generation of communications that may predict or suggest comments or feedback that a user may have as related to their given account activity. Such communications may aid investigators of security breaches by providing user-related context and information relating to the user's activity log, thereby improving the quality of breach detection in data storage systems or other secure systems.

The system may transmit the predicted communication to a user device. For example, the system may send a summary or transcript of the generated predicted communication to a user, for confirmation of the status or concerns that the user has regarding the account. In some implementations, the system may send the predicted communication directly to a user device corresponding to an investigator, rather than to a user of a user account, for pre-emptive monitoring and management of user account security. For example, the system may generate a predicted communication based on a user's activity log that is indicative of a security breach, including a description of a user's possible concerns with regard to the activity log (e.g., particular patterns of activities that are not habitual for the user). The system may transmit these concerns to the user or an investigator to confirm whether these patterns are indeed indicative of a security breach.

In order to train the aforementioned system to generate predictions of expected communications from input activity logs, the system may retrieve activity datasets and communication datasets, as described below. For example, the system may receive a communication dataset and an activity dataset, where the communication dataset includes a plurality of communications with each communication related to a corresponding user. The plurality of communications may include past communications by users of data storage accounts relating to suspected unauthorized actions. For example, such communications may include emails to a data center's security breach detection service regarding files that were not uploaded or downloaded by the user associated with the account. Each communication may be temporally related to a corresponding activity log (e.g., associated with one or a set of unauthorized transactions flagged by the user). In some embodiments, a communication may include a telephonic communication, which may be transcribed into a transcript using a speech recognition model. The activity dataset may include a plurality of activity logs. By receiving both activity logs and corresponding communications, the system enables training of the machine learning model to predict communications based on activity logs.

Based on the plurality of communications, the system may generate a plurality of corresponding vector encodings using the vector encoding model. For example, the system may generate the plurality of vector encodings such that each vector encoding represents natural language of communications in a vector space, such as through a vector encoding model. In some embodiments, the system may generate a plurality of natural language units (e.g., words, phrases, or sentences) that represent each communication, and generate tokens based on numeric representations of these natural language units. By encoding the communications into vector encodings within a defined vector space, the system may prepare the communications in a machine-readable format that may be processed for prediction tasks (e.g., for training of the machine learning model). The generated vector encodings may represent user communications relating to account activity in a manner that preserves their meaning and/or temporal structure, thereby providing important information for training the machine learning model to associate such communications to account activity data.

The system may determine activity classes corresponding to each activity in the plurality of activity logs. For example, the system may determine an associated activity class, of a plurality of activity classes, corresponding to each activity in the plurality of activity logs. Each activity class of the plurality of activity classes may classify activities based on a corresponding criteria of the set of criteria, as described above. For example, the system may generate a list of tokens (e.g., alphanumeric identifiers), each token of which represents an activity class based on pre-determined criteria. For example, the system may generate a representation of whether an activity corresponds to an upload, download, or access event, as well as corresponding file sizes, and encode this information in the form of a string of alphanumeric characters. By doing so, the system classifies activities, which may be complex or account-dependent, into a representation that may be understood system-wide (e.g., across multiple accounts), thereby improving the applicability of activity log data for training the machine learning model.

The system may, based on these activity classes, generate a plurality of time-ordered sequences of tokens for the plurality of activity logs. Each activity log of the plurality of activity logs may have a corresponding time-ordered sequence of tokens, and each activity in each activity log may have a corresponding token of the time-ordered sequence of tokens. Each token of the time-ordered sequence of tokens uniquely identifies the associated activity class, as discussed above. For example, the system may generate time-ordered sequences of alphanumeric tokens representing activity classes for each activity in the activity dataset, thereby generating a system-wide representation of each user's activity data, thus describing the corresponding user's uploads, downloads, or other account-related activity. By doing so, the system enables preparation of the training dataset for training a machine learning model to predict communications based on activities associated with user accounts.

The system may train the machine learning model using the plurality of vector encodings and the plurality of time-ordered sequences. For example, the system may train the machine learning model to predict output vector encodings based on input sequences. The machine learning model enables generation of predictions of expected communications by users based on corresponding input activity logs. As an illustrative example, the system may utilize a backpropagation error minimization technique to train the machine learning model to generate vector encodings of expected communications based on an input time-ordered sequence corresponding to a user's activity over a period of time. By doing so, the system enables prediction of a user's security concerns relating to the user account pre-emptively based on processing of information relating to the account's activity, as discussed above.

Alternatively or additionally, in some implementations, the system may encode user communications and activity logs into the same vector space or encoding space, thereby enabling two-way comparisons between communications and activity logs. For example, the system may encode user activity logs relating to a data storage system, as well as user communications, into the same vector encoding space, such as through a natural language vector encoder. The system may utilize a contrastive learning algorithm to learn to associate the activity's vector encodings with the user communication's vector encodings. By doing so, the system enables investigators to identify analogues with respect to communications or vector encodings. As an illustrative example, an investigator of security breaches within a data center may input a vector encoding of a user's activity log into the contrastive learning model and generate a first vector encoding accordingly. The system may then determine a communication whose vector encoding is most similar to this first vector encoding within a communication dataset, thereby linking the activity log to a similar, past user communication. Alternatively or additionally, the investigator may input an encoded communication into the contrastive learning model to determine a corresponding encoding of an activity log. Thus, the system may determine an activity log from an activity dataset that is consistent with the input communication. By doing so, the system enables two-way translation between user activity data and user communication data, providing investigators with improved contextual information regarding security breaches and any corresponding user impacts.

For example, in some aspects, the system may obtain an input activity log. For example, the input activity log may include a plurality of user activities. The plurality of user activities may have a corresponding plurality of timestamps. In some embodiments, the system may receive a list of activities relating to actions relating to a user's account, such as downloads, including associated values or parameters (e.g., file sizes), as well as corresponding timestamps. By receiving such information relating to a user's activity, the system enables evaluation of patterns within a user's activity over time for prediction of possible user concerns (e.g., through prediction of future user communications).

The system may generate an activity log transformation based on the input activity log. For example, the activity log transformation may represent the input activity log in a first data format, while preserving the order of activities based on the corresponding plurality of timestamps. In some embodiments, the system may convert values for various fields of each activity within the activity dataset into text strings and generate corresponding text labels that characterize each field. For example, an activity within the activity log may include fields indicating a type of account activity (e.g., whether the activity is an upload, download, or access event for a file in a data storage system). Based on these strings of text, the system may concatenate these and generate a textual representation of the input activity log (e.g., the first data format) that describes activity related to the user's account, thereby generating a history of all files transferred into or out of the system. In some embodiments, the system may generate, as the activity log transformation, a time-ordered sequence of tokens, as described above. By converting the activity log into a data format consistent with or convertible with, for example, received user communications, the system may further process the activity log transformation (e.g., by generating corresponding vector encodings) to determine similarities and connections between the activity logs and corresponding user communications.

The system may input the activity log transformation into a vector encoding model to obtain a first output vector encoding. For example, the first output vector encoding may represent the input activity log in a vector space of the vector encoding model. The output vector encoding may include a vector representation of text, for example, by encoding the lexical and syntactic properties of activities within the activity log, as well as the sequence or order of such activities. By generating a vector encoding of the activity log (e.g., through a natural language processing algorithm, such as word2vec or doc2vec), the system may convert activity logs into a format that may be processed by, for example, contrastive learning models, enabling association of activity logs with user communications.

The system may input the first output vector encoding into a contrastive machine learning model to obtain a first matching vector encoding. The first matching vector encoding may represent a first corresponding vector encoding within the vector space of the vector encoding model for a matching communication of a communication dataset. The contrastive machine learning model may be trained based on vector encodings within the vector space. Thus, the system, using the contrastive learning model, may identify or generate a vector encoding that represents a communication, based on a vector encoding that represents an activity log as input. By doing so, the system enables linking of activity logs with associated user communications, through corresponding vector encodings. By generating vector encodings in the same vector space, the association may be in either direction, thereby leading to two-way conversion between information stored in activity logs and information stored in communications. Thus, such a conversion mechanism enables investigators of account-related security breaches (e.g., unauthorized access to files) to access easy-to-understand communications based on a user account's activity, or vice versa, improving the efficiency of any security breach investigation processes.

The system may access vector encodings from a communication database. For example, the system may access a first plurality of vector encodings from a communication database, where each vector encoding of the first plurality of vector encodings represents a corresponding communication of a plurality of communications in the vector space of the vector encoding model. The plurality of communications may be associated with a corresponding plurality of activity logs in an activity dataset. Each communication in the plurality of communications may be associated with a corresponding activity log of the corresponding plurality of activity logs. For example, the system may access vector encodings (e.g., produced through a natural language processing algorithm) that represent the syntax and lexicon of prior user communications relating to corresponding user accounts. By extracting these communications, the system may associate an input activity log with a user communication that is similar in meaning or context to the input activity log. Thus, the system may subsequently learn which activity logs associated with security breaches may be represented by or described by which user communications, thereby enabling the system to provide human-readable context for even complex security breaches and resulting activity logs.

The system may then compare each vector encoding in the first plurality of vector encodings with the first matching vector encoding in order to generate the matching communication. For example, the system may utilize a cosine similarity algorithm to compare each vector encoding in the plurality of vector encodings with the first matching vector encoding and generate a similarity metric for each of these comparisons. Based on determining a maximum similarity metric, the system may identify a vector encoding corresponding to a communication that matches the input activity log. By doing so, the system enables identification of user communications that are similar to, or potentially relevant to, a given activity log. Thus, the system enables investigators to identify analogues to activity logs that are associated with security breaches and corresponding user communications, enabling investigators to understand user concerns with respect to such security breaches. In some embodiments, the system may generate a matching vector encoding for an activity log based on an input communication (e.g., convert between vector encodings in the other direction), thereby identifying communication analogues as well as activity log analogues. Thus, the systems and methods disclosed enable investigators of security breaches to operate on improved information and predictions relating to user communications and corresponding account-related activities.

In order to train the aforementioned contrastive learning model, in some embodiments, the system may leverage an activity dataset and a plurality of communications. For example, the system may retrieve the activity dataset, which includes a plurality of activity logs for different users of the data storage system. Each activity log may be associated with a corresponding plurality of activities (e.g., uploads, downloads, or access events) with associated timestamps. By leveraging information relating to user account activities and corresponding user communications, the system enables training of the contrastive learning model to associate activities with the corresponding communications.

The system may generate a plurality of activity log transformations for each activity log of the activity dataset. Each activity log transformation of the plurality of activity log transformations may represent the corresponding activity log of the plurality of activity logs in the first data format and may preserve the order of activities based on the associated timestamps. These activity logs may describe transactions or actions with respect to a user's account in a data storage system, such as uploads, downloads, or file access requests. For example, the system may generate a time-ordered sequence of tokens corresponding to each activity log, as described above. By doing so, the system prepares the activity dataset in a format that may be system-wide (e.g., may describe activities consistently across user accounts) and that thus may be utilized for training of the contrastive learning model for further association of communications with input activity logs (or, for association of activity logs with input communications).

The system may input each activity log transformation into the vector encoding model to obtain corresponding vector encodings for the activity dataset. For example, the system may input each activity log transformation of the plurality of activity log transformations into the vector encoding model to obtain a second plurality of vector encodings for the activity dataset, wherein each vector encoding of the second plurality of vector encodings represents the corresponding activity log of the plurality of activity logs in the vector space. The system may generate, as an illustrative example, a plurality of vector encodings (e.g., arrays of numerical values) that represent the activity classes and order of activities for each activity log. Thus, the vector encodings may represent the information within activity logs associated with user accounts of data storage systems. Thus, the system may prepare the activity logs as training data in a format that may be subsequently input into the contrastive learning model, consistent with the corresponding communication data.

The system may obtain, from the communication database, the plurality of communications. For example, the system may receive text transcripts or telephonic data corresponding to each communication within the communication database. These communications may be associated with activity logs within the activity dataset (e.g., with user accounts). The communications may include previous user communications expressing concerns with respect to account security (e.g., a user account on a data storage system). By obtaining these communications, the system enables further matching of communications with corresponding activity logs.

The system may input each communication into the vector encoding model to obtain vector encodings corresponding to the communications. For example, the system may input each communication of the plurality of communications into the vector encoding model to obtain the first plurality of vector encodings, wherein each vector encoding of the first plurality of vector encodings represents the corresponding communication of the plurality of communications in the vector space of the vector encoding model. For example, the system may generate a plurality of vectors that encode the syntactical and lexical meaning of each communication based on a natural language processing algorithm. Thus, the vector encodings may express any concerns, comments, or explanations regarding account activity (e.g., particular uploads or downloads) within a data center. By doing so, the system may further train the contrastive learning model to relate communication-related vector encodings to activity log-related vector encodings, thereby enabling conversion between the two embedding spaces for further consideration and processing by investigators of security breaches.

The system may generate a match array as training data for the contrastive machine learning model. For example, the system may generate a match array that includes indicators of whether each communication of the communication dataset matches each activity log of the plurality of activity logs. For example, the match array may include a two-dimensional array, where one dimension represents a communication and the other dimension represents an activity log. An element of the match array corresponding to a given communication and activity log may be marked with a first indicator (e.g., a value of one) if the communication corresponds to the activity log, or with a second indicator (e.g., a value of zero) if the communication does not correspond to the activity log. Thus, the system generates data that enables the contrastive learning model to determine an activity log that may correspond to a communication, or vice versa.

The system may train the contrastive learning model using the match array. For example, the system may train, using the match array, the contrastive learning model to enable matching activity logs with user communications (e.g., using a backpropagation technique). By training the machine learning model as such, the system enables evaluation of user account-related activities in terms of user concerns and understandable language (e.g., language that is consistent with the given activity log). By doing so, the system enables investigators of security breaches (e.g., of unauthorized access to a data storage system) to access information regarding user activity and security breaches in human-readable language, thereby improving the efficiency and efficacy of security breach investigations.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative environment for characterizing user activities using user communications, in accordance with one or more embodiments.

FIG. 2 shows an illustrative schematic of a user activity dataset characterizing activity associated with users, as well as corresponding timestamps, in accordance with one or more embodiments.

FIG. 3 shows an illustrative schematic of a communication dataset characterizing communications associated with users, in accordance with one or more embodiments.

FIG. 4 shows an illustrative flow for encoding communications into a vector space using a vector encoding model, in accordance with one or more embodiments.

FIG. 5 shows an illustrative schematic of a time-ordered sequence of tokens representing a user activity log based on a set of criteria, in accordance with one or more embodiments.

FIG. 6 shows an illustrative schematic of a match array associating activity logs with corresponding communications, in accordance with one or more embodiments.

FIG. 7 shows an example computing system that may be used in accordance with some embodiments of this disclosure, in accordance with one or more embodiments.

FIG. 8 shows a flowchart of the basic operations involved in predicting account-related user communications based on input activity logs, in accordance with one or more embodiments.

FIG. 9 shows a flowchart of the operations involved in training a machine learning model to predict account-related user communications based on input activity logs, in accordance with one or more embodiments.

FIG. 10 shows a flowchart of the basic operations involved in associating account-related user communications within input activity logs, or vice versa, using contrastive learning, in accordance with one or more embodiments.

FIG. 11 shows a flowchart of the operations involved in training a machine learning model to predict account-related user communications based on input activity logs, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

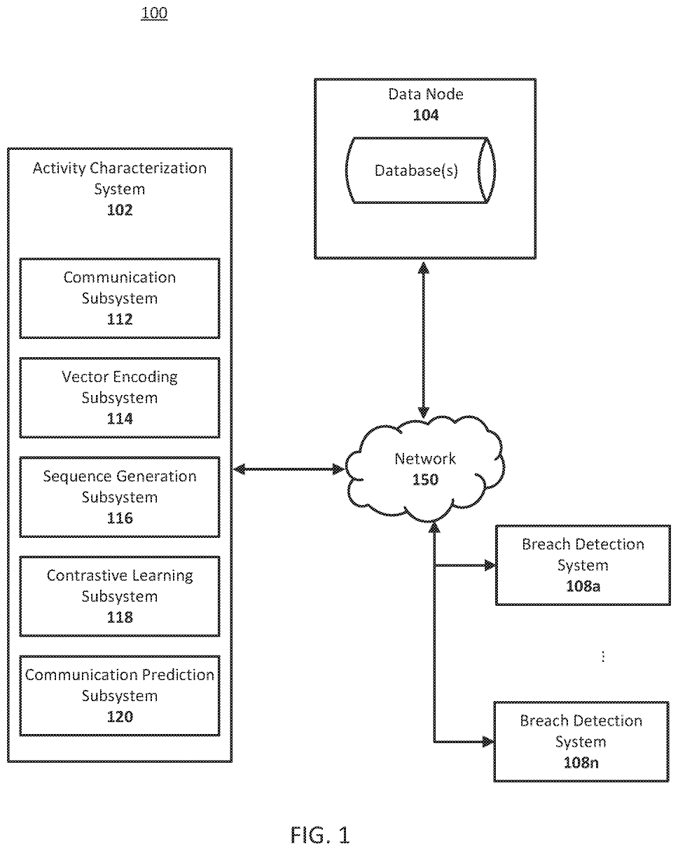

FIG. 1 shows an illustrative environment for characterizing user activities using user communications, in accordance with one or more embodiments. Environment 100 may include activity characterization system 102, data node 104, and one or more breach detection systems 108a-108n, any of which may be configured to communicate with network 150. Activity characterization system 102 may include software, hardware, or a combination of both and may reside on a physical server or a virtual server running on a physical computer system. In some embodiments, activity characterization system 102 may be configured on a user device (e.g., a laptop computer, smartphone, desktop computer, electronic tablet, or another suitable user device). Furthermore, activity characterization system 102 may reside on a server or node and/or may interface with breach detection systems either directly or indirectly.

Data node 104 may store various data, including one or more machine learning models, training data, activity datasets (including activity logs), communication datasets (including verbal conversations), match arrays, and/or other suitable data. Data node 104 may include software, hardware, or a combination of the two. In some embodiments, activity characterization system 102 and data node 104 may reside on the same hardware and/or the same virtual server or computing device. Network 150 may be a local area network, a wide area network (e.g., the internet), or a combination of the two. Breach detection systems 108a-108n may reside on client devices (e.g., desktop computers, laptops, electronic tablets, smartphones, servers, and/or other computing devices that interact with network 150, cloud devices, or servers).

Activity characterization system 102 may receive activity data, communication data, and/or breach-related information (e.g., breach indicators) from one or more devices. Activity characterization system 102 may receive such data using communication subsystem 112, which may include software components, hardware components or a combination of both. For example, communication subsystem 112 may include a network card (e.g., a wireless network card and/or a wired network card) that is associated with software to drive the card and enables communication with network 150. In some embodiments, communication subsystem 112 may also receive data from and/or communicate with data node 104 or another computing device. Communication subsystem 112 may receive data, such as activity logs, communications, match arrays, and/or security breach indicators, such as those pertaining to indicators of fraudulent transactions associated with bank or credit card accounts. Communication subsystem 112 may communicate with vector encoding subsystem 114, sequence generation subsystem 116, contrastive learning subsystem 118, and/or communication prediction subsystem 120.

In some embodiments, activity characterization system 102 may include vector encoding subsystem 114. Vector encoding subsystem 114 may perform tasks that encode data, such as activity log data and/or communication data, into vectors. For example, vector encoding subsystem 114 may generate a vector encoding of a communication utilizing a natural language processing algorithm, such as word2vec and/or doc2vec. Vector encoding subsystem 114 may include software components, hardware components, or a combination of both. For example, vector encoding subsystem 114 may include software components, or may include one or more hardware components (e.g., processors) that are able to execute operations for generating vector encodings from communication data, such as textual communications. Vector encoding subsystem 114 may access data, such as activity logs, token information (including sets of criteria and/or one or more activity class rules), vector encodings, text representations of activity logs, account management rules, and/or predicted communications. Vector encoding subsystem 114 may directly access data, systems, or nodes associated with breach detection systems 108a-108n and may be able to transmit data to such nodes. Additionally or alternatively, vector encoding subsystem 114 may receive data from and/or send data to communication subsystem 112, sequence generation subsystem 116, contrastive learning subsystem 118, and/or communication prediction subsystem 120.

Sequence generation subsystem 116 may execute tasks relating to the generation of sequences of tokens, such as arrays of timestamp-ordered tokens representing activities within activity logs received by communication subsystem 112 from breach detection systems 108a-108n. Sequence generation subsystem 116 may include software components, hardware components, or a combination of both. For example, in some embodiments, sequence generation subsystem 116 may receive a user activity log, including activities and associated timestamps. Sequence generation subsystem 116 may also include one or more sets of criteria. Based on the sets of criteria and the activity log, sequence generation subsystem 116 may generate time-ordered sequences of tokens (e.g., alphanumeric character string identifiers) representing the corresponding user activity log. As an illustrative example, the system may generate a list of representations of activities, such as transactions associated with user bank accounts, where the representations may be alphanumeric characters that categorize the transactions by payment type, merchant, and/or transaction size. Data from sequence generation subsystem 116, such as time-ordered sequences of tokens, may be accessible to communication subsystem 112, vector encoding subsystem 114, contrastive learning subsystem 118, communication prediction subsystem 120, and/or any other components or subsystems of activity characterization system 102.

Contrastive learning subsystem 118 may execute tasks relating to association of activity logs with communications (or vice versa), or other learning tasks relating to data received from communication subsystem 112, vector encoding subsystem 114, sequence generation subsystem 116, and/or communication prediction subsystem 120. Contrastive learning subsystem 118 may include software components, hardware components, or a combination of both. For example, in some embodiments, contrastive learning subsystem 118 may possess or receive activity logs, communications, and/or transformations or encodings thereof. As an illustrative example, contrastive learning subsystem 118 may include one or more machine learning models (e.g., artificial neural networks) that may enable learning of classifications or relationships based on minimization of distances between representations of positive pairs. As such, contrastive learning subsystem 118 may be configured to generate, associate, and/or predict relationships between representations of communications and representations of activities/activity logs. Additionally or alternatively, contrastive learning subsystem 118 may be configured to generate, associate, and/or predict relationships between representations of activities/activity logs and communications. Contrastive learning subsystem 118 may receive corresponding training data, such as match arrays, input data, target data, similarity metrics, indicators of matches, vector encodings (e.g., of communications and/or activity logs), and/or sequences of tokens. Data from contrastive learning subsystem 118, such as predicted vector encodings and/or similarity metrics between communications and activity logs, may be accessible to communication subsystem 112, vector encoding subsystem 114, sequence generation subsystem 116, and/or communication prediction subsystem 120.

Communication prediction subsystem 120 may execute tasks related to predicting user communications based on, for example, activity logs. As an illustrative example, communication prediction subsystem 120 may utilize one or more machine learning models, vector encoding models, and/or natural language processing models for determination of predicted communications based on user activity associated with one or more accounts. As such, communication prediction subsystem 120 may include software components such as application programming interface (API) calls, hardware components, or a combination of both. Communication prediction subsystem 120 may receive (e.g., from communication subsystem 112 or other components of activity characterization system 102) sequences of tokens, vector encodings of communications, and/or other representations of communications and/or activities for training and/or prediction of user communications. Additionally or alternatively, communication prediction subsystem 120 may interface with one or more machine learning models that reside outside of activity characterization system 102 (e.g., on a server accessible through network 150). In some embodiments, communication prediction subsystem 120 may receive data from network 150, data node 104, or breach detection systems 108a-108n. Based on predicted user communications, in some implementations, communication prediction subsystem 120 may generate one or more warnings, messages, or data to communication subsystem 112 for forwarding to one or more breach detection systems 108a-108n through network 150.

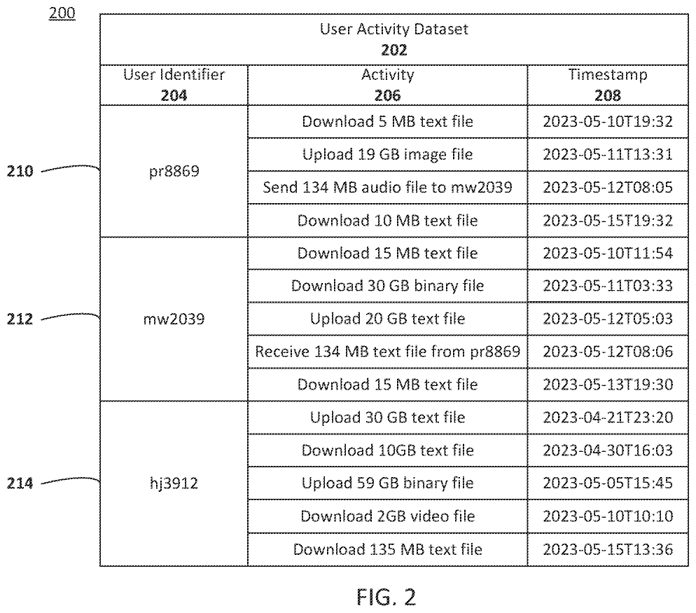

FIG. 2 shows illustrative schematic 200 of a user activity dataset characterizing activity associated with users, as well as corresponding timestamps, in accordance with one or more embodiments. For example, FIG. 2 includes user activity dataset 202, which may include information regarding activities 206 associated with users with user identifiers 204. As an illustrative example, activities 206 may be associated with timestamps 208. For example, activities within user activity dataset 202 may represent, describe, or characterize events associated with a given user's account, such as a network access-related account or a credit card account. By receiving information relating to user activities, activity characterization system 102 enables provision of information that may aid in detection of and/or investigation of security breaches associated with systems.

Communication subsystem 112 may receive a communication dataset and/or an activity dataset. For example, communication subsystem 112 may receive a communication dataset and user activity dataset 202, wherein the communication dataset includes a plurality of communications. Each communication of the plurality of communications may be related to a corresponding user and/or user account. The activity dataset may include a plurality of activity logs. Each activity within each activity log within the activity dataset may be associated with a corresponding plurality of activities with associated timestamps. In some embodiments, communication may be temporally related to a corresponding activity log. For example, the activity dataset may include a list of transactions associated with a user's credit card or bank account. As an illustrative example, communication subsystem 112 may receive activity logs and corresponding communications as training data for training a model to predict communications based on input activity logs. By doing so, activity characterization system 102 may further learn to relate activity logs and predicted communications, thereby enabling prediction of user concerns relating to security breaches, which may be detected or indicated through corresponding activities within the activity logs.

In some embodiments, activity characterization system 102 may receive information relating to accounts. An account (e.g., a user account) may include a collection of information that includes one or more users' identities and privileges for resource access, and that facilitates access of such resources for the user. For example, an account may include a unique identifier, such as an alphanumeric code, as well as associated user identifiers relating to users that have access to the given accounts. User accounts may require authentication credentials for access to resources or may be configured as linked to a device or token. For example, a user account may include a network access account, such as an interface that enables access to websites, web applications, or other network services. In some implementations, a user account may include a credit card account, a bank account, or another financial account that enables access to financial resources. For example, a user account may include a real or virtual account associated with a user. Theft or hacking of user accounts may lead to security breaches, including unwanted activities and loss of data or resources. For example, any breach leading to theft of credentials needed to access a user account may lead to fraudulent activity, transactions, or user activity.

In some embodiments, user activity dataset 202 may include identifiers, such as user identifiers 204. For example, user identifiers 204 may include characters, tokens, or markers that enable association of one or more user activities with a user. Additionally or alternatively, in some embodiments, communication subsystem 112 may receive an account identifier associated with activities within an activity log or an activity dataset. For example, activity characterization system 102 may receive a numeric, 16-digit identifier of a credit card account, with corresponding transaction information within the activity log. By receiving an identifier associated with the account relating to activity logs, activity characterization system 102 enables further association of activity with corresponding communications (as well as other attributes) of the account. Such account-related context may improve the efficiency and efficacy of breach detection or investigation of security breaches.

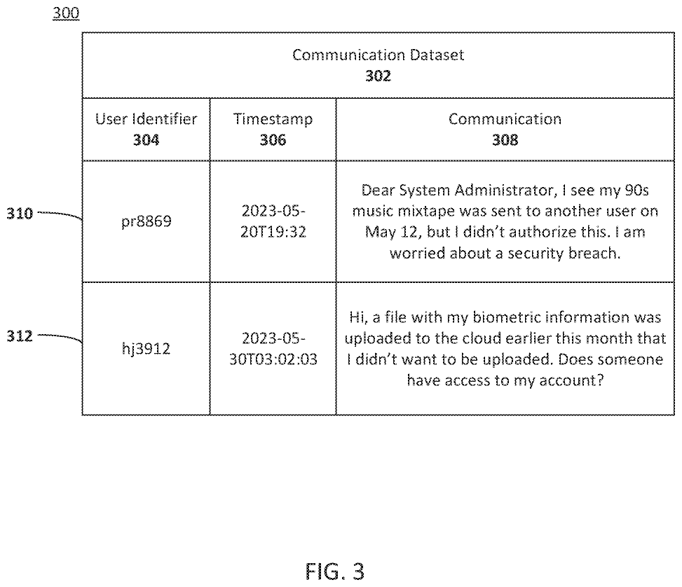

In some embodiments, activity characterization system 102 may enable detection or investigation of events related to a corresponding account. For example, communication subsystem 112 may receive communications associated with events related to corresponding accounts. For example, an event may include any activity, set of activities, or patterns deemed to be anomalous or notable. As an illustrative example, an event may include one or more security-related user events (e.g., indicative of a security breach), such as an activity taking place during an abnormal or irregular time as compared to other activity associated with the account. An event may include a transaction associated with an account, such as a credit card account, that occurred outside of a normal geographic region or other habitual characteristic associated with the user account, with no warning or knowledge by users associated with the given account. Alternatively or additionally, an event may include an authorized network access event, such as an unauthorized download, upload, or a transfer of files within a network. As described below in relation to FIG. 3, communications may be descriptive of such events. By receiving information relating to anomalous events associated with user accounts, activity characterization system 102 enables monitoring, detection, and investigation of potential security breaches within a controlled access system, such as a data storage center or a credit card or bank account.

In some embodiments, a security breach may include any incident that results in unauthorized access to resources, information, applications, or networks. For example, a security breach may include an incident that results in theft of credential information relating to an account. In the illustrative case of a credit card or bank account, a security breach may include a situation in which a malicious entity gains access to account numbers, personal identification numbers, security codes (e.g., CVV codes), and/or expiration dates in a manner that enables the malicious entity to access funds or lines of credit. Additionally or alternatively, a security breach may include events or incidents relating to unauthorized access to a device, network, program, or data, such as theft of authentication credentials (e.g., passwords, usernames, and/or two-factor authentication keys), or any other methods that enable bypassing of underlying security mechanisms for unauthorized entities. Because security breaches are often identified by users associated with corresponding accounts, account activity and user communications relating to events related to security breaches may provide useful information for evaluation and/or investigation of the presence of security breaches within user accounts.

Communication subsystem 112 may receive, for a user account, an input activity log. For example, in order to evaluate a user's account for indications of security breaches, communication subsystem 112 may receive an activity log (e.g., one of activity logs 210-214 as shown in FIG. 2), where the activity log includes a list of user activities, such as transactions (e.g., withdrawals, deposits, or purchases associated with a bank account and/or credit card account). Each user activity in the list of user activities may have a corresponding activity timestamp, such as one of timestamps 208. Additionally or alternatively, communication subsystem 112 may obtain an input activity log (e.g., for a user account), such as through a request to a server, through an API, or through extraction from a database. For example, communication subsystem 112 may obtain an input activity log, wherein the input activity log includes a plurality of user activities with a corresponding plurality of timestamps. By receiving information relating to a particular user's or account's activity, activity characterization system 102 may evaluate associated activity for any suspicious events (e.g., indicative of security breaches), thereby enabling dynamic monitoring and mitigation of the effects of anomalous events or activity.

In some embodiments, obtaining the input activity log may include determining a subset of activities based on timestamps of the activities within the input activity log. For example, communication subsystem 112 may receive a user activity log, where the user activity log includes a plurality of activities, and where the plurality of activities has an associated plurality of timestamps. Based on comparing each timestamp of the associated plurality of timestamps with a threshold timestamp, communication subsystem 112 may determine a subset of the associated plurality of timestamps. Communication subsystem 112 may generate the input activity log to include a subset of the plurality of activities, where each activity of the subset of the plurality of activities has a corresponding timestamp of the subset of the associated plurality of timestamps. As an illustrative example, communication subsystem 112 may receive an activity log corresponding to a given user of a bank account system, where activities within the activity log span a given period of time and include transaction information, including deposits, withdrawals, and account-related inquiries. Communication subsystem 112 may determine which activities took place recently, within a threshold amount of time, based on their corresponding timestamps.

For example, communication subsystem 112 may compare each timestamp of each activity of the user activity log with a threshold timestamp, where the threshold timestamp is determined by a threshold amount of time from a timestamp corresponding to receipt of the user activity log. By doing so, activity characterization system 102 may only consider activities that may be relevant to a given security breach concern. In some embodiments, communication subsystem 112 may compare the activity timestamps with two or more threshold timestamps (e.g., an earlier and a later timestamp) and select the subset of the plurality of activities based on whether a given activity timestamp lies within or outside of the two or more threshold timestamps. For example, by doing so, communication subsystem 112 enables activity characterization system 102 to have flexibility and control over activities considered in an analysis of a given security breach event (e.g., through selection of temporally relevant activities), leading to improved breach detection and investigation.

In some embodiments, an activity timestamp may include an indication, marker, or label associated with a time of an activity. An activity timestamp may include an indication of a date and time of the completion or execution of a given task. As an illustrative example, an activity timestamp may include an indication of a time at which a user associated with an account completed a transaction (e.g., a purchase) with a merchant at a point of sale. Additionally or alternatively, an activity timestamp may include an indication of a time at which a user received, transmitted, uploaded, or downloaded a file. By including activity timestamps, activity characterization system 102 enables consideration of activities relevant to a given security breach or other event (e.g., by selection of activities within a range or threshold of times). Moreover, activity timestamps enable sequence generation subsystem 116 to generate sequences of tokens while retaining information regarding patterns of activities (e.g., patterns of bank withdrawals and/or transactions) that may be indicative of a security breach.

In some embodiments, an activity dataset may include information or data relating to users or accounts and associated activities, events, or transactions. For example, an activity dataset may include any representation of activities within a system or a network categorized by user and/or account, such as user activity dataset 202 in FIG. 2. User activity dataset 202 may include one or more activity logs 210-214, each of which describes activities 206, corresponding timestamps 208, and associated user identifiers 204. Additionally or alternatively, an activity dataset may include a transaction database. For example, the transaction database may include information relating to transactions (e.g., purchases, bank transfers, check deposits, or other account-related activities), including associated accounts and timestamps. User activity datasets enable training of models associated with contrastive learning subsystem 118 and/or communication prediction subsystem 120 by providing system-wide information regarding security breaches and corresponding activities associated with users or accounts.

In some embodiments, an activity log (e.g., an input activity log and/or a user activity log) may include an indication of activities, events, or tasks corresponding to a user, account, or system. For example, activity log 212, corresponding to user identifier “mw2039,” includes information regarding a plurality of activities associated with the corresponding user. An activity log may be stored within one or more databases on data node 104, and may be expressed in tabular, array-like, or vector-like structures. Each activity within the plurality of activities may exhibit an associated timestamp (e.g., timestamp 208). A reference activity log may include any activity log used for comparison, reference, or as an analogue. For example, a reference activity log may include an activity log within an activity database corresponding to a communication that is deemed similar to another input activity log for another user.

Activities within an activity log may include descriptions, indications, or markers of activities performed by one or more users or accounts (e.g., an upload initiated by a user, or a purchase initiated by a user of a credit card account at a merchant). Additionally or alternatively, an activity may include descriptions, indications, or markers of activities associated with the account but not performed by the associated user or account (e.g., passive activities). For example, an activity may include a receipt of a text file or of funds or may include an unauthorized purchase by an entity not authorized to act on behalf of the user and/or account. As an illustrative example, an activity may include a text string describing an event associated with a user or an account. An activity may, alternatively or additionally, include one or more fields (e.g., as in an electronic form) describing the given activity. For example, an activity may include an “Event” field describing an event (e.g., a purchase), along with a “Value” field indicating a value associated with an event (e.g., a monetary value of the purchase), and an associated timestamp. By receiving information regarding such activities, activity characterization system 102 may generate representations of predicted communications associated with accounts or users that may be subject to a security breach (e.g., through a machine learning model and/or a contrastive learning model). Additionally or alternatively, communication prediction subsystem 120 may utilize information regarding activities for training models to generate such representations of communications.

In some embodiments, activities may include user activity metadata. User activity metadata may correspond to each user activity of a list of user activities. For example, user activity metadata may include information characterizing the nature or type of activity. A description of the activity (e.g., a text string characterizing the activity) within a corresponding activity log may include user activity metadata, which communication subsystem 112 may extract. Additionally or alternatively, an activity may include user activity metadata in the form of fields, such as fields that indicate a resource type and/or a resource size associated with the activity. By including user activity metadata, sequence generation subsystem 116, for example, may generate representations or transformations of activity logs (e.g., time-ordered sequences of tokens or other activity log transformations) in a universal, system-wide, or process-wide manner.

In some embodiments, user activity metadata may include a plurality of fields and a plurality of corresponding values. For example, user activity metadata may include a series of fields that enable categorization or characterization of activities, with corresponding values of fields characterizing the given activity. As an illustrative example, a field may include an “activity type” label (e.g., a text label) indicating a classification or type of an activity (e.g., where the corresponding value indicates whether the activity is a “purchase,” a “download,” or a “transfer”). In some embodiments, a field may include a resource type and/or a resource size, with corresponding values indicating a type of resource associated with the activity (e.g., a text string indicating that an activity is directed toward a transfer of currency) and a size of the resource (e.g., a number indicating the value of the currency being transferred). Additionally or alternatively, a resource type may include an indication of a “file,” “binary,” or other type of electronic/digital resource, while a resource size may indicate a corresponding memory footprint or size (e.g., in megabytes or gigabytes, or a transfer rate, such as a file download rate expressed in megabytes per second). A field may exhibit its own descriptive text label indicating the nature of the field in its own right. For example, a field text string may include the text string “activity type” and/or “resource size.” By describing activities through fields (as well as describing the nature of the fields themselves), communication subsystem 112 may more universally and accurately characterize the nature of a given activity, enabling improved predictions of associated user communications, security breach events, or other attributes.

FIG. 3 shows illustrative schematic 300 of communication dataset 302 characterizing communications associated with users, in accordance with one or more embodiments. For example, communication dataset 302 may include communication entry 310 or communication entry 312. Communications within communication dataset 302 may include corresponding user identifiers 304, timestamps 306, and/or communications 308. For example, communication subsystem 112 may receive, obtain, or store communication entries from or within a communication database.

In some embodiments, a communication may include any medium, process, or data for exchanging information between two or more entities using one or more channels. For example, a communication may include signals, messages, data, voice, video, images, or any other form of information that may be transmitted or received. In some embodiments, a communication may include text, such as emails, instant messages, text messages, documents, or letters. A communication may include audio, speech, music, and/or other signals. For example, a communication may include an audio file of a conversation between two or more entities or may include an audio file of a message in Morse code. Communications may include representations of conversations between one or more entities.

Additionally or alternatively, communication subsystem 112 may extract portions of communications between one or more entities. For example, a communication may only include phrases, words, or sentences spoken by or generated by a single entity or a subset of entities. Communications may include conversations or messages with entities associated with a given system. For example, communications may include service requests to an administrator of a network access system, or an alert message by a user to a bank or alternative financial institution regarding suspected fraud or a security breach within a user's account. For example, a user communication may include a communication arising from a user of an account within a system. In some embodiments, a communication may include a plurality of such messages, conversations, or audio. By receiving communications associated with user accounts, activity characterization system 102 may evaluate relationships between activities associated with user accounts and any related communications. As such, activity characterization system 102 enables prediction of related communications that may aid in investigations of security breaches, as indicated by user account activity.

In some embodiments, communication subsystem 112 may receive communications that include voice communications. For example, voice communications may include any communication corresponding to spoken words. Voice communications may include communications generated and/or transmitted through phones, radios, intercoms, or VOIP (voice over internet protocol). As an illustrative example, a voice communication may include an audio file that includes human speech in one or more natural languages. Voice communications may include telephonic communications (e.g., communications over telephones, such as landlines or mobile devices, or similar devices).

In some embodiments, communication subsystem 112 may handle textual representations of communications. For example, a textual representation of a communication may include a textual communication, or a transcription of a non-text communication. For example, a textual representation of a communication may include an email, text message, transcript of an audio conversation, or transcript of a video call. By receiving or generating textual representations of communications, communication subsystem 112 enables conversion of communications into a similar format for processing, in a manner that enables treatment of different types of communications for association with activity logs. As an illustrative example, communication subsystem 112 may receive an email corresponding to a first user account and a telephonic communication corresponding to an audio file. Communication subsystem 112 may, for example, using a speech-to-text algorithm or a speech recognition model, generate a telephonic transcript of the telephonic conversation. In some embodiments, the telephonic transcript may include a textual representation of an audio file corresponding to a telephonic conversation. The telephonic transcript may include indications of entities speaking during different portions of the telephonic conversation, enabling improved discernment of user concerns (e.g., versus investigator or administrator concerns) for the corresponding user account.

In some embodiments, communication subsystem 112 may extract metadata corresponding to communications. For example, metadata may include any information, data, or context relating to a communication. For example, communication entries 310 or 312 shown in FIG. 3 may include metadata, including user identifiers 304 and/or timestamps 306 corresponding to associated communications 308. In some embodiments, a timestamp for a communication may include an indication, marker, or label associated with a time of a communication. A timestamp may include an indication of a date and time of the transmission, receipt, or generation of a given communication. As an illustrative example, a communication timestamp may include an indication of a time at which a user associated with an account initiated a phone call with a fraud investigation specialist associated with a financial institution. By including metadata relating to a communication, communication subsystem 112 may associate or link communications with user activities based on metadata, including timestamps and user identifiers. For example, communication subsystem 112 may associate a subset of activities to a communication based on timestamps associated with the activities and the communication, as well as matching user identifiers.

In some embodiments, a speech recognition model may include a system for conversion of signals into text or other forms of output. For example, a speech recognition model may include a speech-to-text model that may convert speech (e.g., an audio file of a telephonic conversation) into text (e.g., a telephonic transcript). In some embodiments, communication subsystem 112 may convert human speech to other data formats. For example, a speech recognition model may convert speech into a speech of a different language (e.g., translation), or may convert identified speech into other formats, such as braille, Morse code, or electronic or electromagnetic signals. For example, a speech recognition model may utilize machine learning models, such as artificial neural networks, or may utilize algorithms that process n-grams. By converting speech to a different format, communication subsystem 112 may prepare any audio or speech communications in a manner that enables subsequent processing (e.g., through machine learning models or contrastive learning models) for association of such communications with corresponding user account activity.

In some embodiments, communications may include information submitted through electronic forms. Form data may include information submitted through an electronic form by a user associated with a user account. For example, an electronic form may include a form with text associated with fields within the form. Such fields may include textboxes, checkboxes, drop-down menus, or other features that may be present within a graphical user interface. In some embodiments, communication subsystem 112 may encrypt or decrypt information within electronic forms or any other communications. By extracting information relating to forms, communication subsystem 112 may consider information submitted by users in particular situations. For example, a user may fill out a form to request investigation of a security breach or suspected fraud associated with a user account, which may include information relevant to detection, evaluation, and investigation of such security breaches.

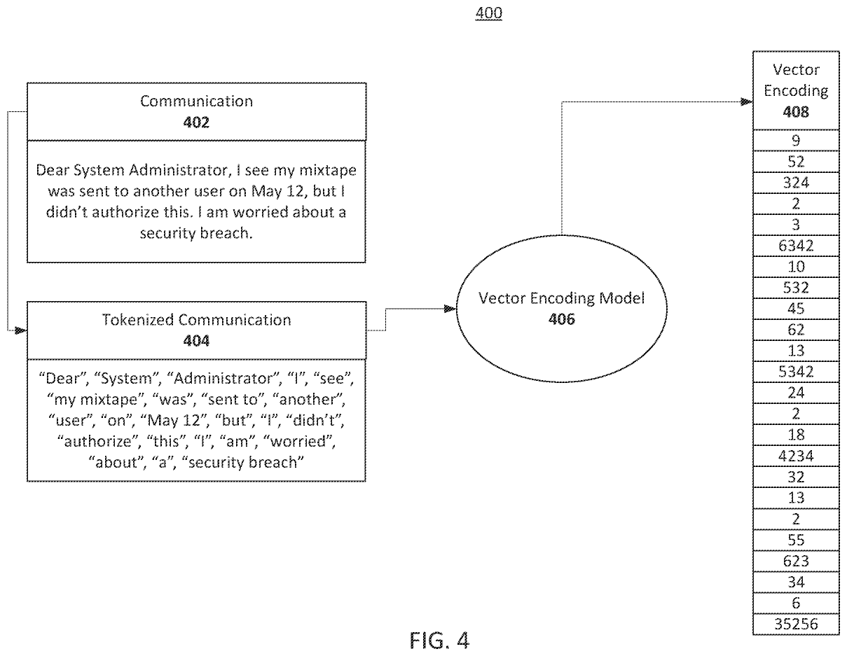

FIG. 4 shows illustrative flow 400 for encoding communications into a vector space using a vector encoding model, in accordance with one or more embodiments. For example, vector encoding subsystem 114 may generate tokenized communication 404 based on communication 402 by, for example, separating a text string corresponding to communication 402 into words, phrases, or sentences. Vector encoding subsystem 114 may convert the tokenized communications into vector encoding 408 using vector encoding model 406. By doing so, the system enables further processing of communications for prediction of security-related account events based on user account activity.

In some embodiments, vector encoding subsystem 114 may generate a plurality of vector encodings using the vector encoding model. For example, using the vector encoding model, vector encoding subsystem 114 may generate a plurality of vector encodings for the plurality of communications, wherein the plurality of vector encodings represents natural language of communications in a vector space. As an illustrative example, vector encoding subsystem 114 may utilize vector encoding model 406 to generate a vector representation of a given communication (e.g., vector encoding 408). In some embodiments, vector encoding model 406 may include natural language processing algorithms, such as word2vec or doc2vec, which enable conversion of words or sentences to vector space. Vector encoding subsystem 114 may generate vector encoding 408, which may include a vector of a particular number of dimensions within a defined vector space. For example, a word, phrase, sentence, or communication may be represented by one or more lists of numbers that are able to capture semantic and syntactic qualities of words and/or phrases. By encoding communications in a defined vector space, the system may enable analytical comparisons between communications of varying sizes or formats by conversion to a uniform format. Furthermore, distances and/or directions within the vector space may indicate information relating to the meaning of a communication, thereby capturing information that may improve the ability of the activity characterization system 102 to make connections and evaluate associated user activity. By generating many vector encodings for different communications associated with different users, the system enables training of machine learning models to associate communications with activity data associated with different users.

In some embodiments, vector encoding subsystem 114 may utilize a vector encoding model. A vector encoding model may include any model that is capable of encoding communications, alphanumeric characters, and/or verbal information in a vector representation. For example, a vector encoding model may include natural language processing algorithms, as defined above, which may include neural networks or other unsupervised learning algorithms. Alternatively or additionally, a vector encoding model may include supervised tools or algorithms capable of converting text data into numerical vectors, including bag-of-words, term frequency-inverse document frequency, and/or fastText. A vector encoding may include any numerical representation of words, phrases, or communications. By including vector encoding models, vector encoding subsystem 114 prepares communication or other verbal data in a form that is suitable for input and further processing, such as by other machine learning models. As such, activity characterization system 102 may improve classification and/or predictions of user account-related activities based on user communications or vice versa.

Vector encodings may be determined or defined over a vector space. A vector space may include mathematical structures that represent collections of vectors. For example, a vector encoding may represent a word or communication by defining spaces or points within a vector space that represent the meaning of the words or ideas within a given document or communication. In some embodiments, the coordinates of a given word or communication in a vector space may be determined by the context in which the word or communication appears, in order to capture the meaning of multiple words or ideas within a given communication. In some embodiments, a vector space may have a defined dimensionality (e.g., a number of dimensions). By defining vector encodings using a vector space, vector encoding subsystem 114 enables uniform comparisons and pattern-recognition across multiple communications spanning different contexts, users, or circumstances, thereby improving the robustness and accuracy of predictive analytics based on account-related communication data.

In some embodiments, vector encoding subsystem 114 may convert communications into tokens based on generating natural language units from the communication. For example, generating the plurality of vector encodings for the plurality of communications may include generating, based on a first communication of the plurality of communications, a plurality of natural language units, wherein each natural language unit of the plurality of natural language units represents any one of a word, a phrase, or a sentence. Vector encoding subsystem 114 may separate communication 402 into groups of alphanumeric characters, where each group represents a semantic or syntactic unit in natural language. A natural language unit may include characters, words, phrases, sentences, paragraphs, or other portions of verbal data that may include meaning (e.g., syntax, lexicon, or semantic information) in a natural language context. As an illustrative example, vector encoding subsystem 114 may separate words such as “system” and “administrator” into separate tokens while combining words such as “security” and “breach” into a phrase “security breach,” based on the meaning of the corresponding words or phrases. The system may populate an array of these natural language units. By doing so, the system may encode the meaning of a communication more accurately by pre-processing the data according to the meaning of phrases and words.

In some embodiments, vector encoding subsystem 114 may utilize the natural language units to generate the plurality of vector encodings for the plurality of communications. For example, based on the plurality of natural language units, vector encoding subsystem 114 may generate an array of natural language tokens, wherein each natural language token of the array of natural language tokens includes a corresponding numeric representation of each natural language unit of the plurality of natural language units. Based on inputting the array of natural language tokens into the vector encoding model, vector encoding subsystem 114 may generate the plurality of vector encodings for the plurality of communications. As an illustrative example, vector encoding subsystem 114 may consider each array of natural language units corresponding to each communication and generate a numerical representation of each unit within the array (e.g., as shown in vector encoding 408 of FIG. 4), such as by assigning each natural language unit a corresponding number. By doing so, vector encoding subsystem 114 may capture the meaning of complex communications through encoding individual natural language units as components of vectors.

In some embodiments, vector encoding subsystem 114 may generate vector encodings based on telephonic communications corresponding to users. For example, vector encoding subsystem 114 may determine that a first communication of the communication dataset includes a first telephonic communication, wherein the first telephonic communication comprises audio data of a conversation between two users. Based on inputting the first telephonic communication into a speech recognition model, vector encoding subsystem 114 may generate a first telephonic transcript for the first communication. Vector encoding subsystem 114 may generate the plurality of vector encodings to include a first vector encoding of the first telephonic transcript. For example, communication subsystem 112 may receive audio data (e.g., an audio file) of telephonic data from a user to a system administrator, such as of a user calling a system administrator to notify them of unauthorized behavior or access to the corresponding account. As information from telephonic communications may be material to the detection or prediction of security-related account activities, vector encoding subsystem 114 may process such communications in a manner that enables further analysis. For example, vector encoding subsystem 114 may generate a transcript using a speech recognition model, where the transcript may include a textual representation of the telephonic conversation (e.g., including labels of speakers and the content of the conversation). A speech recognition model may include a model that outputs text corresponding to spoken words, phrases, sentences, or communications. By generating a vector encoding based on this telephonic transcript, activity characterization system 102 may leverage non-textual communications for further analysis of account activity and/or security-related events in situations where communications are not originally textual (e.g., spoken or signed).

In some embodiments, vector encoding subsystem 114 may generate vector encodings of information submitted through forms (e.g., electronic and/or web-based forms). For example, vector encoding subsystem 114 may determine that a first communication of the communication dataset includes first form data, wherein the first form data includes information submitted, through an electronic form, by the corresponding user associated with a corresponding user account. Based on extracting text from fields associated with the first form data, vector encoding subsystem 114 may generate a first array of natural language units, wherein each natural language unit of the first array of natural language units represents any one of a word, a phrase, or a sentence. Based on inputting the first array of natural language units into the vector encoding model, vector encoding subsystem 114 may generate the plurality of vector encodings to include a first vector encoding of the first form data. For example, activity characterization system 102 may enable users to send in reports of suspicious account activity through electronic forms, which may include text fields, radio buttons, drop-down menus, or other information submission mechanisms. As such, vector encoding subsystem 114 may generate vector encodings of electronic form data, improving the flexibility of the system to handle a variety of user communication types.

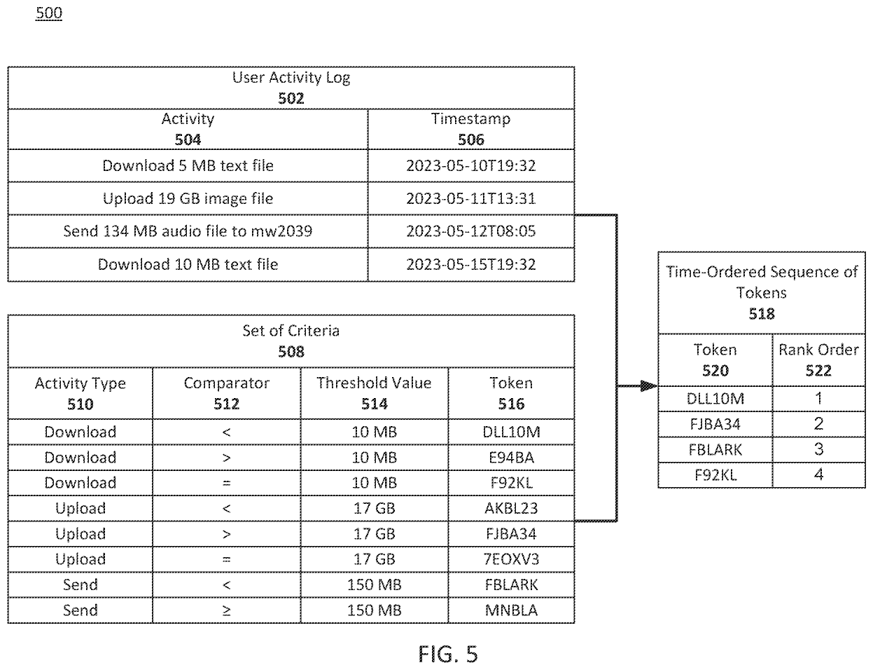

Additionally or alternatively, vector encoding subsystem 114 may encode activity data in the form of vector encodings. For example, vector encoding subsystem 114 may generate a plurality of activity log transformations, wherein each activity log transformation of the plurality of activity log transformations represents the corresponding activity log of the plurality of activity logs in the first data format and preserves the order of activities based on the associated timestamps. An activity log transformation may include any transformation of an activity log into another data format or representation, such as for improved processing or analysis. As an illustrative example, vector encoding subsystem 114 may convert a user's activity log (e.g., one of activity logs 210-214) into alphanumeric strings and/or arrays of tokens based on text within the corresponding activity data. In some embodiments, as described below in relation to FIG. 5, sequence generation subsystem 116 may generate an activity log transformation that corresponds to a time-ordered sequence of tokens. By doing so, activity characterization system 102 may extract meaning from activity data by further vectorizing the data using natural language processing methods. As such, vector encoding subsystem 114 enables accurate comparisons and analysis of both communications and activities, as well as any relationships thereof.

In some embodiments, vector encoding subsystem 114 may generate user text representations of activities as activity log transformations. Text representations of activities may include written or printed words, phrases, or sentences that describe activities, such as user account-related activities. For example, a text representation may include an alphanumeric text string with words describing the nature of an activity, including associated timestamps, users, user accounts, or other contextual information relating to the activity. By generating a text representation of activity data, vector encoding subsystem 114 may transform activity information into the same format as communications, thereby improving the ability of activity characterization system 102 to analyze relationships between communications and activities.

In some embodiments, the system may generate vector encodings based on the activity log transformations. For example, vector encoding subsystem 114 may input each activity log transformation of the plurality of activity log transformations into the vector encoding model to obtain a second plurality of vector encodings for the activity dataset, wherein each vector encoding of the second plurality of vector encodings represents the corresponding activity log of the plurality of activity logs in the vector space. As an illustrative example, vector encoding subsystem 114 may submit a representation of activity data (e.g., in the form of text strings and/or an array of natural language tokens) into vector encoding model 406 for generation of a corresponding vector encoding (e.g., vector encoding 408). By doing so, the system may enable comparison and/or translation between activities and corresponding user communications, thereby improving the accuracy and flexibility of analysis of user communications and associated account-related events or activities.

In some embodiments, vector encoding subsystem 114 may communicate with communication subsystem 112 to receive communications corresponding to users. For example, vector encoding subsystem 114 may obtain, from a communication database, a plurality of communications. Vector encoding subsystem 114, for example, may retrieve textual communications and/or telephonic communications from the communication database in order to analyze the relationship between communications and activities as related to user accounts. By doing so, activity characterization system 102 may generate predictions and/or analyze relationships between communications and activities in a manner that enables evaluation and mitigation of security-related events associated with user accounts.

In some embodiments, the system may receive voice communications (e.g., telephonic communications) from the communication database that pertain to users of the system. For example, vector encoding subsystem 114 may receive, from the communication database, a plurality of voice communications, wherein the plurality of voice communications comprises audio files including human speech. Using a speech-to-text model (e.g., a speech recognition model), vector encoding subsystem 114 may generate a plurality of textual representations, wherein each textual representation of the plurality of textual representations comprises a corresponding text string representing a corresponding voice communication of the plurality of voice communications. Vector encoding subsystem 114 may store the plurality of textual representations as the plurality of communications. For example, vector encoding subsystem 114 may convert any audio files that include telephonic communications or video conversations into text using a speech recognition model and store these textual representations as the communications. By doing so, vector encoding subsystem 114 ensures that communication data is uniformly stored as text, even if arising from different communication formats, thereby improving the efficiency and flexibility of any subsequent data processing steps.

In some embodiments, vector encoding subsystem 114 may input each communication of the plurality of communications into the vector encoding model to obtain the first plurality of vector encodings, wherein each vector encoding of the first plurality of vector encodings represents the corresponding communication of the plurality of communications in the vector space of the vector encoding model. For example, as discussed above, vector encoding subsystem 114 may generate vector encoding 408 for communications (e.g., communication 402) based on tokenization (e.g., generation of tokenized communication 404) and input these tokens into vector encoding model 406. Vector encoding subsystem 114 may generate these vector encodings such that the encodings are embedded in a uniform or pre-determined vector space to enable further communication and analysis of patterns within communication data, as well as their relationship to corresponding activity data.

FIG. 5 shows illustrative schematic 500 of a time-ordered sequence of tokens representing a user activity log based on a set of criteria, in accordance with one or more embodiments. For example, sequence generation subsystem 116, as shown in FIG. 1, compares activities 504 within user activity log 502 with set of criteria 508 in order to generate time-ordered sequence of tokens 518. By classifying activities based on their type and generating tokens based on these classifications, sequence generation subsystem 116 enables analysis (e.g., pattern-recognition) based on a wide range of activity types, improving the accuracy of predictions based on such account-related activities. By generating a time-ordered sequence of such tokens, sequence generation subsystem 116 encodes the order of activities pertaining to given user accounts, thereby retaining information that may enable the improved accuracy of predictions of security events.

Sequence generation subsystem 116 may generate a plurality of tokens based on set of criteria 508. For example, sequence generation subsystem 116 may generate a plurality of tokens based on a set of criteria, wherein each token in the plurality of tokens includes a corresponding alphanumeric identifier that represents a corresponding activity class for a corresponding user activity of the list of user activities, wherein each corresponding alphanumeric identifier is determined based on one or more activity class rules, and wherein the one or more activity class rules indicate rules for classifying user activities into corresponding activity classes. In some embodiments, sequence generation subsystem 116 may determine an associated activity class, of a plurality of activity classes, corresponding to each activity in the plurality of activity logs, wherein each activity class of the plurality of activity classes classifies activities based on a corresponding criteria of the set of criteria. As an illustrative example, the system may determine a token for each activity that is associated with a user based on the nature of that activity. For example, a download of a file below a particular file size may be assigned a different token than an upload of a file above another particular file size. By classifying user activities into tokens, sequence generation subsystem 116 may process a variety of activities, of diverse types, in a manner that enables comparisons between different activities, activities in different accounts, and/or activities associated with different users, in a uniform way.

In some embodiments, sequence generation subsystem 116 may determine activity classes for activities within an activity log. As an illustrative example, an activity class may include a description or characterization of an activity. An activity class may include a description of a type of resource transferred into or out of an account, such as a file, financial resources (e.g., currencies), or a description of a transaction. For example, an activity class may include a specification that a given account activity is a transaction for a purchase at a restaurant for greater than 50 dollars. Activity classes may be defined by one or more activity class rules, such as a set of criteria, as shown in FIG. 5.

Sequence generation subsystem 116 may determine activity classes based on set of criteria 508. Sets of criteria may include rules, classification guidelines, or specifications for characterizing activities into activity classes. For example, set of criteria 508 includes rules for classifying activities into tokens 516 that represent activity classes based on activity types 510, comparators 512, and threshold values 514. As an illustrative example, user activity log 502 may include activities 504, one of which may be described as a download of a 5 MB text file. Set of criteria 508 may include a criterion that includes an activity type of a “download,” with a comparator of “less than” and a threshold value of 10 MB, indicating that the corresponding activity may be associated with or described by the corresponding criterion (e.g., an activity class rule). As such, sequence generation subsystem 116 may classify an activity with a token, which may include an alphanumeric identifier (e.g., alphanumeric identifier “DLL10M”). By using sets of criteria to classify activities, sequence generation subsystem 116 may describe various activities with a uniform framework or representation, thereby enabling system-wide analysis of user account-related activities for further processing.

Sequence generation subsystem 116 may generate tokens to represent activity classes of given activities. A token may include a representation of an activity class corresponding to an activity. In some embodiments, a token may include an alphanumeric identifier that represents criteria for classifying a given activity with a given activity class. For example, a token may include a string of characters, such as “DLL10M,” where a set of characters may indicate an activity type (e.g., “DL” may indicate a download), a set of characters may indicate a comparator (e.g., “L” may indicate a “less than” condition), a set of characters may indicate a value (e.g., “10” may represent a threshold value associated with the comparator), and a set of characters may indicate a unit (e.g., “M” may indicate megabytes). In some embodiments, different schemes may exist for designation of a token. By generating tokens associated with activities, the system may describe activities associated with different accounts, users, or times using a unified representation scheme.

In some embodiments, sequence generation subsystem 116 may generate activity classes based on the set of criteria. For example, sequence generation subsystem 116 may retrieve, from the activity dataset, a first activity log corresponding to a first user account, wherein the first activity log comprises a first plurality of user activities and a corresponding plurality of activity timestamps. Sequence generation subsystem 116 may determine, based on the set of criteria, the associated activity class for each activity within the first activity log. Based on determining the associated activity class for each activity within the first activity log, sequence generation subsystem 116 may generate a set of time-ordered activity classes corresponding to the first activity log.

Sequence generation subsystem 116 may generate a time-ordered sequence of tokens based on the plurality of tokens. For example, based on the plurality of tokens, sequence generation subsystem 116 may generate time-ordered sequence of tokens 518, wherein each token in the time-ordered sequence of tokens may be ordered based on the corresponding activity timestamp (e.g., timestamps 506) associated with the corresponding user activity for each token. In some embodiments, sequence generation subsystem 116 may generate a plurality of time-ordered sequences of tokens for the plurality of activity logs, wherein each activity log of the plurality of activity logs has a corresponding time-ordered sequence of tokens, wherein each activity in the plurality of activity logs has a corresponding token of the time-ordered sequence of tokens, and wherein each token of the time-ordered sequence of tokens uniquely identifies the associated activity class. Alternatively or additionally, in some embodiments, sequence generation subsystem 116 may generate a set of tokens corresponding to the set of time-ordered activity classes, wherein each token of the set of tokens comprises an associated alphanumeric identifier representing each activity class of the set of time-ordered activity classes. Based on the set of tokens corresponding to the set of time-ordered activity classes, sequence generation subsystem 116 may generate the corresponding time-ordered sequence of tokens for the first activity log using the corresponding plurality of activity timestamps.

As an illustrative example, sequence generation subsystem 116 may generate time-ordered sequence of tokens 518 out of tokens 520, where their rank order 522 is dependent on timestamps 506. Sequence generation subsystem 116 may store such a sequence within a data structure, such as an array, for further processing (e.g., for inputting into one or more machine learning models). For example, a time-ordered sequence of tokens may include a list of identifiers of tokens within a data structure that enables preservation of order (e.g., by storing each identifier with a corresponding rank indicator). By preserving information relating to the order of events related to an account, activity characterization system 102 may ensure that any temporal patterns within user account activity are captured, as these patterns may be material in determining the presence of security-related events, such as account breaches. Furthermore, communications relating to user accounts may be linked to the order in which account activities occurred. As such, by preserving the order of activities within activity data, the system may relate communications with corresponding activity logs, enabling improved account-related predictions.

In some embodiments, sequence generation subsystem 116 or vector encoding subsystem 114 may generate an activity log transformation for an activity log in an analogous manner. As an illustrative example, activity characterization system 102 may generate, based on the input activity log, an activity log transformation, wherein the activity log transformation represents the input activity log in a first data format, and wherein the activity log transformation preserves temporal order of activities. For example, vector encoding subsystem 114 may generate a textual representation of the activity log by converting descriptions associated with activities into text strings, as described above in relation to FIG. 4. Alternatively or additionally, sequence generation subsystem 116 may generate a time-ordered sequence of tokens in a similar manner as described above in order to generate the activity log transformation.

The activity log transformation may represent activity logs (e.g., lists of activities) in a data format. A data format may include any representation of information, such as an activity log, in a predetermined form. For example, vector encoding subsystem 114 may encode a list of activities within an activity log in a textual data format, where activities are described using alphanumeric characters within verbal text. Alternatively or additionally, sequence generation subsystem 116 may encode activities within a data format represented by a corresponding time-ordered sequence of tokens. By converting the activity-related information into a given data format, activity characterization system 102 ensures the portability and flexibility of any further analysis, as such data formats improve the processability of information that may be originally encoded in distinct ways.

In some embodiments, sequence generation subsystem 116 may generate an activity log transformation in an analogous manner. For example, sequence generation subsystem 116 may generate a plurality of tokens based on a list of user activities within the input activity log, wherein each token of the plurality of tokens comprises a corresponding alphanumeric identifier that represents a corresponding activity class for a corresponding user activity of the list of user activities, and wherein each corresponding alphanumeric identifier is determined based on one or more activity class rules, and wherein the one or more activity class rules indicate rules for classifying user activities into corresponding activity classes. Based on the plurality of tokens, sequence generation subsystem 116 may generate, as the activity log transformation, a time-ordered sequence of tokens, wherein each token in the time-ordered sequence of tokens is ordered based on a corresponding activity timestamp associated with the corresponding user activity for each token.

The activity log transformation may include a textual representation of activity within the activity log, as described above. For example, sequence generation subsystem 116 may generate a plurality of tokens based on a list of user activities within the input activity log, wherein each token of the plurality of tokens comprises a corresponding text string that represents a corresponding activity class for a corresponding user activity of the list of user activities, and wherein each corresponding text string is determined based on one or more activity rules, and wherein the one or more activity rules indicate rules for representing user activities using text. Based on the plurality of tokens, sequence generation subsystem 116 may generate, as the activity log transformation, a textual representation of the input activity log, wherein the textual representation of the input activity log comprises the plurality of tokens. By enabling the conversion of activity data into various data formats, sequence generation subsystem 116 improves the flexibility of any activity analysis by enabling the activity data to be processed using different representations.

In some embodiments, the activity log transformation may include extracting activity metadata, such as fields and corresponding text labels, and generating a textual representation thereof. For example, sequence generation subsystem 116 or vector encoding subsystem 114 may determine, for a first activity of the input activity log, a plurality of fields and a plurality of corresponding values, wherein a corresponding value for each field of the plurality of fields characterizes the first activity. Activity characterization system 102 may generate a plurality of text labels corresponding to the plurality of fields, wherein each text label of the plurality of text labels comprises a corresponding field text string characterizing a corresponding field of the plurality of fields. Based on concatenating each text label of the plurality of text labels with the corresponding field text string, activity characterization system 102 may generate a first textual representation of the first activity. As such, activity characterization system 102 may generate the activity log transformation to include the first textual representation of the first activity. Thus, activity characterization system 102 may handle activity data, such as transactions, that are stored in a label or field-comprising data structure, enabling improved handling of different formats of activity log data.

In some embodiments, vector encoding subsystem 114 may generate a vector encoding based on the activity log transformation. For example, vector encoding subsystem 114 may input the activity log transformation into a vector encoding model to obtain a first output vector encoding, wherein the first output vector encoding represents the input activity log in a vector space of the vector encoding model. As discussed in relation to FIG. 4, textual information, such as textual information relating to activities within an activity log, may be encoded using a vector representation in a vector space (e.g., using a natural language processing algorithm). As such, vector encoding subsystem 114 enables the conversion of such an activity log transformation to a format that may, for example, preserve lexical, syntactic, or other information relating to the activities associated with a user account. By generating vector encodings thereof, activity characterization system 102 enables further analysis or comparison between activity data and communication data, as both may be represented as vectors.

Activity characterization system 102, such as through vector encoding subsystem 114 shown in FIG. 1, may encode communications in a data format through a communication transformation. For example, non-textual verbal communications (e.g., telephonic communications) may be converted to textual communications that represent the communications using alphanumeric strings of characters. As such, activity characterization system 102 enables communication data and activity data to be transformed into similar or desired data formats to improve the flexibility and/or uniformity of further processing and evaluation.

In some embodiments, sequence generation subsystem 116 may retrieve activity logs associated with communications based on associated account identifiers. For example, sequence generation subsystem 116 may retrieve a first communication from the plurality of communications. Based on first metadata corresponding to the first communication, sequence generation subsystem 116 may identify a corresponding user identifier and a corresponding communication timestamp. Based on the corresponding user identifier and the corresponding communication timestamp corresponding to the first communication, sequence generation subsystem 116 may retrieve a first activity log. Based on the first activity log, sequence generation subsystem 116 may generate a first time-ordered sequence of tokens for the plurality of time-ordered sequences. As an illustrative example, for the purpose of training a machine learning model to relate users' communications with corresponding activity logs, sequence generation subsystem 116 may retrieve activity logs that are already linked to communications based on metadata corresponding to the communication, such as a user identifier associated with a communication, as well as a timestamp. For example, sequence generation subsystem 116 may retrieve activities that are associated with previous user communications relating to account breaches. As a result, sequence generation subsystem 116 improves the ability of machine learning models to be trained to relate or associate user communications with corresponding activity data, improving the efficiency and accuracy of the machine learning models for prediction and analysis of user activities.

In some embodiments, communication prediction subsystem 120 enables improving the quantity of training data based on generating a seed vector encoding based on the first time-ordered sequence of tokens. For example, communication prediction subsystem 120 may generate, using the vector encoding model, a first vector encoding for the first communication, wherein the first vector encoding represents natural language of the first communication in the vector space. Based on inputting the first time-ordered sequence of tokens into the machine learning model, communication prediction subsystem 120 may generate a seed vector encoding, wherein the seed vector encoding represents syntax and lexicon for a seed communication based on the first activity log. Based on inputting the seed vector encoding into the machine learning model, communication prediction subsystem 120 may generate a resulting sequence of tokens, wherein the resulting sequence of tokens represents a predicted activity log based on the seed communication. Communication prediction subsystem 120 may generate training data for training the machine learning model to predict the output vector encodings based on the input sequences, wherein the training data comprises the first vector encoding and the resulting sequence of tokens. For example, based on a predicted communication generated from the first time-ordered sequence of tokens, communication prediction subsystem 120 may generate a corresponding communication. By re-encoding this communication as a sequence of tokens based on inputting the seed communication into the machine learning model, communication prediction subsystem 120 enables generation of further training data for training the machine learning model, thereby improving the machine learning model's predictive ability.

In some embodiments, generating alphanumeric identifiers for user activities may include extracting metadata regarding the activity and comparing activities with criteria from a set of criteria. For example, sequence generation subsystem 116 may extract, from a user activity dataset, user activity metadata corresponding to each user activity of the list of user activities. Based on comparing the user activity metadata with each criteria of the set of criteria, sequence generation subsystem 116 may determine the corresponding activity class for each user activity of the list of user activities. Sequence generation subsystem 116 may generate the corresponding alphanumeric identifier for each user activity of the list of user activities, wherein the corresponding alphanumeric identifier for each user activity of the list of user activities uniquely identifies the corresponding activity class for each user activity of the list of user activities. As an illustrative example, sequence generation subsystem 116 may determine that an activity corresponds to a transaction that is a purchase (e.g., a payment on a user's credit card account) at Merchant A for a price of x dollars. User activity metadata may include any such information describing an activity, such as a transaction type, a merchant identifier, and/or a price. A set of criteria may specify that an activity of a “transaction” type, at Merchant A of a price below T dollars may correspond to a particular activity class and, therefore, a corresponding alphanumeric identifier. Thus, sequence generation subsystem 116 may generate tokens (e.g., alphanumeric identifiers) based on comparing such metadata with criteria. By generating the activity class based on these criteria, sequence generation subsystem 116 enables description of activities system-wide based on predetermined rules, improving the quality of any subsequent analysis.

For example, determining a token corresponding to a given user account activity may include extracting a resource type and/or a resource size corresponding to the activity and comparing this information with given criteria. For example, sequence generation subsystem 116 may extract, from first user activity metadata corresponding to a first user activity of the list of user activities, a first resource type associated with the first user activity, wherein the first resource type indicates a classification of a first resource associated with the user account. Sequence generation subsystem 116 may extract, from the first user activity metadata, a first resource size associated with the first user activity, wherein the first resource size indicates classification of a size of the first resource. Sequence generation subsystem 116 may determine a first alphanumeric identifier for the first user activity, wherein the first alphanumeric identifier identifies an activity class corresponding to the first resource type and the first resource size. As an illustrative example, a transaction may include information relating to the type of item purchased (e.g., a type of resource), as well as a size relating to the resource (e.g., a value describing the resource, such as a price). For example, a user account activity may include activity metadata specifying that the activity was for the purchase of jewelry (e.g., a resource type) of a certain price (e.g., a resource size). Such metadata may influence evaluation of security breaches, as, for example, activities indicative of large transfers of resources for high-value objects may be more likely to be associated with fraudulent or criminal activity. As such, by encoding such information within a representation of a user account's activity data, sequence generation subsystem 116 enables improved detection and evaluation of user activities, as well as related communications.

By inputting such activity-related information, such as the time-ordered sequence of activities, into a machine learning model, communication prediction subsystem 120 may generate predicted representations of communications that may be related to the given activity data. For example, based on inputting the time-ordered sequence of tokens into a machine learning model, communication prediction subsystem 120 may generate an output vector encoding, wherein the output vector encoding represents syntax and lexicon for a predicted communication based on the input activity log. As an illustrative example, information relating to a user's credit card account transaction history may be encoded as a time-ordered sequence of tokens, as described previously. By inputting this representation of the transaction history into a machine learning model, communication prediction subsystem 120 may predict a possible user communication relating to the history. For example, if the time-ordered sequence of tokens describes a pattern of activities that may indicate a likely security breach (e.g., fraudulent activity relating to unauthorized transactions), the machine learning model may generate a communication that predicts that a user may flag such unauthorized communications to a system administrator. By doing so, the system improves the predictive ability of user account systems, such that the systems may mitigate security breaches or other events prior to the user noticing such events. Furthermore, such predicted communications may provide descriptive information characterizing the corresponding user account activities, enabling investigators to operate on improved information.

A machine learning model may include unsupervised or supervised algorithms. For example, a machine learning model may output a vector encoding of a predicted communication based on representations of activity logs (e.g., activity log transformations or time-ordered sequences of tokens). In some embodiments, machine learning models may employ contrastive learning or other possible algorithms for generating predicted communications. Alternatively or additionally, machine learning models may provide representations of activity logs based on input communications. As such, machine learning models enable activity characterization system 102 to characterize account-related activity information, improving the quality, efficiency, and accuracy of security breach detection and any subsequent investigation.

For example, machine learning models may be trained using pluralities of vector encodings of communications and corresponding time-ordered sequences. Using the plurality of vector encodings and the plurality of time-ordered sequences, communication prediction subsystem 120 may train the machine learning model to predict output vector encodings based on input sequences, wherein the machine learning model enables generation of predictions of expected communications by users based on corresponding input activity logs. As such, activity characterization system 102 may leverage encoded information relating to user communications, as well as associated activity data, in order to generate predictions or warnings relating to account-related events or further user communications based on input activity information, improving the ability of activity characterization system 102 to protect the security of user accounts.

In some embodiments, contrastive learning subsystem 118 may enable generation of predictions relating to communications based on inputting vector encodings into a contrastive machine learning model. For example, contrastive learning subsystem 118 may input the first output vector encoding into a contrastive machine learning model to obtain a first matching vector encoding in the vector space, wherein the first matching vector encoding represents a first corresponding vector encoding for a matching communication of a communication dataset, and wherein the contrastive machine learning model has been trained based on vector encodings within the vector space. Communication prediction subsystem 120 may produce matching communications by comparing the matching vector encoding with a vector encoding previously stored within a communication database. For example, communication prediction subsystem 120 may access a first plurality of vector encodings from a communication database, wherein each vector encoding of the first plurality of vector encodings represents a corresponding communication of a plurality of communications in the vector space of the vector encoding model. By doing so, contrastive learning subsystem 118 enables generation of communications that may be similar to communications that have already been received relating to account activity. Thus, contrastive learning subsystem 118 enables matching of communications relating to account-related security breaches with input activity data, thereby providing context to investigators or administrators relating to security breaches or other events associated with account information.

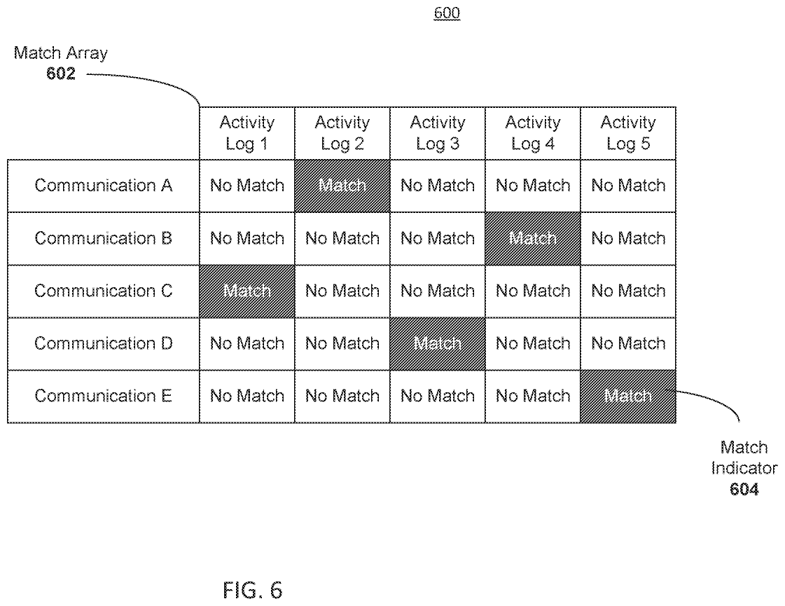

Contrastive learning subsystem 118 may utilize one or more contrastive learning models to generate or convert between vector encodings of communications and/or vector encodings of activity logs. For example, a contrastive learning model may include supervised or unsupervised techniques that enable extraction of features within data by minimizing the distance between representations of positive pairs (e.g., data that is similar), and maximizing the distance between representations of negative pairs (e.g., data that is dissimilar). Thus, contrastive learning allows machine learning models to learn higher-level features about data for classification. As an illustrative example, contrastive learning models disclosed herein may learn to generate vector representations of communications based on inputted vector representations of activity data, or vice versa, based on information relating to the similarity or dissimilarity of activity data and communications. Training of such a contrastive learning model is discussed in relation to FIG. 6 below.

In some embodiments, communication prediction subsystem 120 may generate predicted communications based on output vector encodings from a machine learning model. For example, based on inputting the output vector encoding into a vector encoding model, communication prediction subsystem 120 may generate the predicted communication. As an illustrative example, the machine learning model, based on a time-ordered sequence of tokens corresponding to a user's activity log, may output a corresponding vector encoding that is associated with textual or communication data. By doing so, communication prediction subsystem 120 enables generation of information (e.g., an output vector encoding) relating to possible account-related user communications based on activities within the corresponding user's activity log. By inputting this vector encoding into a vector encoding model, vector encoding subsystem 114 may translate this representation into text (e.g., to a human-readable form), or another verbal format. Additionally or alternatively, communication prediction subsystem 120 may transmit the predicted communication to a user device for further processing. By doing so, activity characterization system 102 enables characterization of patterns within user account activity by predicting possible user communications based on such user activity, thereby providing a predictive mechanism for investigators or account administrators to investigate security breach information or other account-related events.

Thus, communication prediction subsystem 120 may generate such a communication for display, for purposes of further processing, examination, or investigation by a user or administrator. For example, based on comparing each vector encoding in the first plurality of vector encodings with the first matching vector encoding, communication prediction subsystem 120 may generate, for display on a user interface, the matching communication. By generating the matching communication on a user interface, a user or an investigator may utilize information within the communication to predict or evaluate events associated with the associated account, thereby improving the security breach mitigation tools available to investigators of fraudulent activity or other malicious events.

In some embodiments, generating the matching communication based on the matching vector encoding may include generating vector similarity metrics. For example, communication prediction subsystem 120 may determine a vector similarity metric, wherein the vector similarity metric indicates similarity between a first vector encoding of the first plurality of vector encodings and the first matching vector encoding. Communication prediction subsystem 120 may determine, based on the vector similarity metric, that the first vector encoding matches the first matching vector encoding. Based on determining that the first vector encoding matches the first matching vector encoding, communication prediction subsystem 120 may generate, for display on the user interface, the matching communication, wherein the matching communication corresponds to the first vector encoding. For example, the communication database may include vector encodings of previous communications received in relation to user accounts. By comparing the vector encodings using a vector similarity metric, communication prediction subsystem 120 may determine a matching vector encoding and a corresponding communication that is most likely to be relevant to or associated with the input activity log and corresponding vector encoding. By doing so, communication prediction subsystem 120 provides improved context to users, evaluators, investigators, and/or administrators relating to an account's security status.

Communication prediction subsystem 120 may generate similarity metrics or vector similarity metrics. A similarity metric may include a quantitative measure of comparison between two data elements, such as two vectors. For example, a vector similarity metric may include a cosine similarity or an inner product, which may characterize degree of similarity between the directions of vector encodings in the vector space. Thus, by generating a vector similarity metric, communication prediction subsystem 120 may better predict communications that are likely to be associated with account activity data, thereby improving the accuracy of account-related predictions thereof.

In some embodiments, communication prediction subsystem 120 may determine a vector encoding that may be most likely to be similar to the matching vector encoding based on comparing similarity metrics. For example, communication prediction subsystem 120 may generate a plurality of similarity metrics, wherein each similarity metric of the plurality of similarity metrics indicates a corresponding measure of similarity between a corresponding vector encoding of the first plurality of vector encodings and the first matching vector encoding. Based on comparing each similarity metric of the plurality of similarity metrics with other similarity metrics of the plurality of similarity metrics, communication prediction subsystem 120 may generate a similar vector encoding. Based on determining that the similar vector encoding corresponds to the first corresponding vector encoding for the matching communication, communication prediction subsystem 120 may generate the matching communication. For example, communication prediction subsystem 120 may generate similarity metrics to determine the degree of similarity between any pre-existing vector encodings associated with previously received account-related communications and the matching vector encoding generated by the contrastive learning model. By comparing these similarity metrics with each other, communication prediction subsystem 120 may determine a highest similarity metric, for example, thereby enabling selection of a more relevant vector encoding and corresponding communication. By doing so, communication prediction subsystem 120 enables improved selection of relevant communications that may be associated with a given input activity log, improving the information provided to a user regarding the user's account.

In some embodiments, communication prediction subsystem 120 may improve account-related search results for users based on the matching communication associated with a user's activity. For example, communication subsystem 112 may receive, from a user device associated with the input activity log, a first search query comprising a first text string. Communication prediction subsystem 120 may generate, based on the matching communication, a second text string associated with the input activity log. Communication prediction subsystem 120 may generate a second search query comprising the first text string and the second text string. Communication subsystem 112 may transmit the second search query to a search engine, wherein the search engine provides search results based on the second search query. Communication subsystem 112 may cause the user device to display the search results. For example, by evaluating information relating to a user's query, as well as communications that are likely to be relevant to the user's previous activity data, activity characterization system 102 may provide improved search results to the user's query by including such relevant information from the matching communication. By doing so, activity characterization system 102 improves the user experience by tailoring their queries to the context associated with their user account history.

In some embodiments, communication prediction subsystem 120 may generate a prediction for an account event based on an activity log corresponding to the matching communication. For example, communication prediction subsystem 120 may, based on comparing the matching communication with an entry of the communication database, determine a reference user identifier corresponding to the matching communication. Based on the reference user identifier, communication prediction subsystem 120 may extract, from an activity database, a reference activity log corresponding to the matching communication. Communication prediction subsystem 120 may generate, based on the reference activity log, a prediction for an account event for a user corresponding to the input activity log. As illustrative examples, an account event may include a security breach (e.g., unauthorized access to the user account), a fraudulent transaction, or a determination of a change in account status. For example, communication prediction subsystem 120 may determine that the matching communication is associated with another user account with a corresponding account history that indicates unauthorized access to the account. By inspecting this account history, communication prediction subsystem 120 may predict a likely trajectory for the input activity log's corresponding account, thereby improving the quality of predictions of account-related events.

In some embodiments, communication prediction subsystem 120 may determine a user account status based on predicted communications and/or matching communications. For example, based on the predicted communication, communication prediction subsystem 120 may determine a user account status, wherein the user account status indicates a risk level for the user account. Communication prediction subsystem 120 may generate a recommendation for a system security action, wherein the recommendation includes a suggested warning message to a user of the user account based on the user account status. As an illustrative example, communication prediction subsystem 120 may determine whether a predicted or matching communication may be associated with a user account status. A user account status may include an indication (e.g., an account status indicator) of the health, state, or security of an account, such as whether an account is likely associated with a security breach. As such, communication prediction subsystem 120 enables characterization of a user account based on its account activity by leveraging relevant or predicted communications. Alternatively or additionally, communication prediction subsystem 120 enables recommendations for system actions to prevent security breaches, for example, such as deactivation of a user account suspected of a security breach or issuance of a warning to a corresponding user. For example, a system security action may include any action that may be taken as related to an account's security. Thus, communication prediction subsystem 120 may generate a warning message to warn users, administrators, or investigators of possible adverse account statuses based on such information, thereby mitigating the effect of any possible security breaches.

In some embodiments, determining the account status may include comparing information within the predicted communication with key phrases in a key phrase database. For example, communication prediction subsystem 120 may extract, from a key phrase database, a plurality of key phrases, wherein each key phrase of the plurality of key phrases is associated with an account status indicator, wherein the account status indicator comprises an indication of an explanation of the input activity log. Based on determining that the predicted communication includes a first key phrase of the plurality of key phrases, communication prediction subsystem 120 may determine a first account status indicator for the user account status. For example, a key phrase database may include a collection of key phrases that may have associated indicators that describe or characterize a user's account status. For example, a communication that includes a phrase “I didn't make a purchase on that date” may indicate that the account status is “Breached,” based on a key phrase stored in a database, such as “didn't make a purchase.” Thus, communication prediction subsystem 120 enables prediction of account status based on predicted communications associated with an account's activity data.

In some embodiments, communication prediction subsystem 120 may determine a security action based on account management rules that are stored within a ruleset. For example, based on comparing the user account status with account management rules in an account management ruleset, communication prediction subsystem 120 may determine a first account management rule corresponding to the user account status, wherein the account management ruleset comprises a plurality of rules for suggesting account actions based on account statuses. Communication prediction subsystem 120 may generate the recommendation for the system security action to include a description of the first account management rule. Account management rules may include suggestions or protocols relating to an account based on the account's determined status. For example, an account management rule within a set of rules may include a suggestion to deactivate any accounts associated with an account status of “Breached” to prevent any further security breaches or loss of information or property. By doing so, communication prediction subsystem 120 enables unsupervised mitigation of possible security risks in response to determining that a security breach may be likely.

FIG. 6 shows illustrative schematic 600 of a match array associating activity logs with corresponding communications, in accordance with one or more embodiments. For example, contrastive learning subsystem 118 may train one or more contrastive learning models using match array 602, which may include elements that include match indicators, such as match indicator 604. By doing so, contrastive learning subsystem 118 may learn based on whether representations of communications match corresponding activity logs, thereby enabling classification or determination of analogues for input activity logs or communications.

For example, contrastive learning subsystem 118 may generate a match array based on whether communications match activity logs within training data. Contrastive learning subsystem 118 may generate a match array, wherein the match array comprises indicators of whether each communication of the communication dataset matches each activity log of the plurality of activity logs. For example, match array 602 may include indicators (e.g., match indicator 604) of whether a given communication (e.g., Communication A) matches activity logs (e.g., Activity Log 2), or whether there is no match. Thus, contrastive learning subsystem 118 may train, using the match array, the contrastive machine learning model to enable matching activity logs with user communications.

A match array may include a data structure that indicates whether each communication of a communication dataset matches each activity log of a set of activity logs. For example, a match array may be two-dimensional, with each element associated with a corresponding communication and a corresponding activity log. Thus, each element of the array may include a match indicator (e.g., match indicator 604) that indicates whether the communication and activity log are, for example, associated with the same user account and, therefore, whether there is a match. For example, a match indicator may include a corresponding value or token (e.g., a numerical value of one for a match and a value of zero for a lack of a match). By including this information, contrastive learning subsystem 118 may train the contrastive learning model to associate activity logs with communications that have been determined to be relevant or similar, thereby enabling contextual comparisons and evaluations of account activity and communications.

For example, in some embodiments, generating the match array may include determining whether user identifiers corresponding to an activity log match user identifiers corresponding to a communication. Contrastive learning subsystem 118 may determine, using the communication database, a first user identifier for a first communication in the plurality of communications. Contrastive learning subsystem 118 may determine, using the activity dataset, a second user identifier for a first activity log in the plurality of activity logs. Based on comparing the first user identifier and the second user identifier, contrastive learning subsystem 118 may generate an indication of a match. Contrastive learning subsystem 118 may generate the match array to include the indication of the match within an element of the match array that corresponds to the first communication and the first activity log. For example, for a given element of the match array (which, as explained above, may correspond to a particular communication and activity log), contrastive learning subsystem 118 may determine whether that particular communication and activity log are associated with the same user identifier or not; based on this identification, contrastive learning subsystem 118 may determine the corresponding match indicator. By doing so, contrastive learning subsystem 118 enables matching communications with activity logs that are likely to be associated with each other (e.g., the same user), thereby enabling the contrastive learning model to find similarities between such communications and their corresponding activity logs.

In some embodiments, each element of the match array may be associated with a corresponding index from lists of indices corresponding to different communications or activity logs. For example, contrastive learning subsystem 118 may generate a first list of indices, wherein each index of the first list of indices labels the corresponding activity log of the plurality of activity logs. Contrastive learning subsystem 118 may generate a second list of indices, wherein each index of the second list of indices labels the corresponding communication of the plurality of communications. Contrastive learning subsystem 118 may generate, as the match array, a match matrix comprising a plurality of elements, wherein each element of the plurality of elements is associated with a corresponding first index of the first list of indices and a corresponding second index of the second list of indices, and wherein each element of the plurality of elements indicates that the corresponding activity log of the corresponding first index matches the corresponding communication of the corresponding second index. For example, an index may include a number associated with a given communication and/or a given activity log. Thus, by indexing elements of the match matrix, contrastive learning subsystem 118 may define a data structure with which to populate match array 602, thereby enabling improved processing of the match array to train the corresponding contrastive learning model.

In some embodiments, contrastive learning subsystem 118 may determine tokens that indicate matches for training the contrastive learning model. For example, contrastive learning subsystem 118 may determine a first vector encoding from the first plurality of vector encodings and a second vector encoding from the second plurality of vector encodings. Contrastive learning subsystem 118 may determine, using the match array, a token indicating whether a first communication represented by the first vector encoding matches a first activity log represented by the second vector encoding. Based on the token indicating a match, contrastive learning subsystem 118 may generate, within a training dataset, input data comprising the first vector encoding and target data comprising the second vector encoding. Based on the input data and the target data, contrastive learning subsystem 118 may train the contrastive machine learning model to output a new vector encoding that represents an activity log or a user communication in the vector space to enable matching the activity logs with the user communications. For example, contrastive learning subsystem 118 may determine input data that may include vector encodings corresponding to communications. Additionally or alternatively, contrastive learning subsystem 118 may generate target data based on other vector encodings corresponding to the matching activity log information, based on whether each activity log matches with the corresponding communication (e.g., based on the match array). As such, contrastive learning subsystem 118 may generate training data to train the contrastive learning model using the match array.

Alternatively or additionally, such training data may be based on numerical values corresponding to similarity between communications and activity logs. For example, contrastive learning subsystem 118 may determine a first vector encoding from the first plurality of vector encodings and a second vector encoding from the second plurality of vector encodings. Contrastive learning subsystem 118 may determine, using the match array, a numerical value indicating whether a first communication represented by the first vector encoding matches a first activity log represented by the second vector encoding. Contrastive learning subsystem 118 may generate, within a training dataset, input data and target data, wherein the input data comprises the first vector encoding and the second vector encoding, and wherein the target data comprises the numerical value. Thus, contrastive learning subsystem 118 may train the contrastive machine learning model using the training dataset to output a similarity metric between an encoded communication and an encoded activity log. As such, contrastive learning subsystem 118 may be trained based on indicators of how well a communication matches an activity log, thereby enabling the contrastive learning model to output information relating to the relevance of a communication to an input activity log, or vice versa.

For example, in some embodiments, activity characterization system 102 may generate activity data based on input communications from users. For example, activity characterization system 102 may receive an input communication. Activity characterization system 102 may generate, based on the input communication, a communication transformation, wherein the communication transformation represents the input communication in the first data format. Activity characterization system 102 may input the input communication into the vector encoding model to obtain a second output vector encoding, wherein the second output vector encoding represents the input communication in the vector space of the vector encoding mode. Activity characterization system 102 may input the second output vector encoding into the contrastive machine learning model to obtain a second matching vector encoding, wherein the second matching vector encoding represents a second corresponding vector encoding within the vector space of the vector encoding model for a matching activity log of the activity dataset. Activity characterization system 102 may access the second plurality of vector encodings from an activity database. Based on comparing each vector encoding in the second plurality of vector encodings with the second matching vector encoding, activity characterization system 102 may generate, for display, the matching activity log on the user interface. Thus, activity characterization system 102 enables prediction of possible account-related activities based on communications. By doing so, activity characterization system 102 enables predictions of possible security events before they may have even occurred, improving the ability of the account system to detect security breaches.

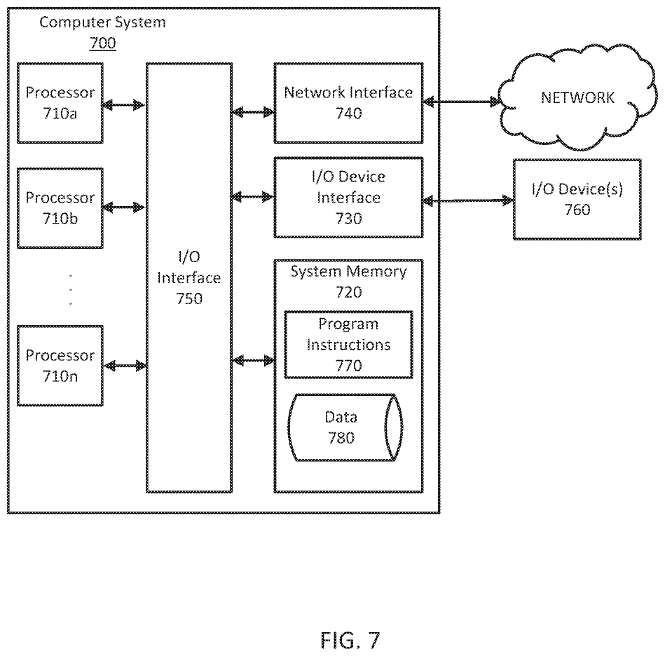

FIG. 7 shows an example computing system that may be used in accordance with some embodiments of this disclosure. In some instances, computing system 700 is referred to as a computer system 700. A person skilled in the art would understand that those terms may be used interchangeably. The components of FIG. 7 may be used to perform some or all operations or generate, transmit, or handle all data discussed in relation to FIGS. 1-6. Furthermore, various portions of the systems and methods described herein may include or be executed on one or more computer systems similar to computing system 700. Further, processes and modules described herein may be executed by one or more processing systems similar to that of computing system 700.

Computing system 700 may include one or more processors (e.g., processors 710a-710n) coupled to system memory 720, an input/output (I/O) device interface 730, and a network interface 740 via an I/O interface 750. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computing system 700. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 720). Computing system 700 may be a uni-processor system including one processor (e.g., processor 710a), or a multi-processor system including any number of suitable processors (e.g., processors 710a-710n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, for example, an FPGA (field-programmable gate array) or an ASIC (application-specific integrated circuit). Computing system 700 may include a plurality of computing devices (e.g., distributed computer systems) to implement various processing functions.

I/O device interface 730 may provide an interface for connection of one or more I/O devices 760 to computer system 700. I/O devices may include devices that receive input (e.g., from a user) or output information (e.g., to a user). I/O devices 760 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 760 may be connected to computer system 700 through a wired or wireless connection. I/O devices 760 may be connected to computer system 700 from a remote location. I/O devices 760 located on remote computer systems, for example, may be connected to computer system 700 via a network and network interface 740.

Network interface 740 may include a network adapter that provides for connection of computer system 700 to a network. Network interface 740 may facilitate data exchange between computer system 700 and other devices connected to the network. Network interface 740 may support wired or wireless communication. The network may include an electronic communication network, such as the internet, a local area network (LAN), a wide area network (WAN), a cellular communications network, or the like.

System memory 720 may be configured to store program instructions 770 or data 780. Program instructions 770 may be executable by a processor (e.g., one or more of processors 710a-710n) to implement one or more embodiments of the present techniques. Program instructions 770 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 720 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, ROM, PROM, EPROM, EEPROM), volatile memory (e.g., random access memory (RAM), static random-access memory (SRAM), synchronous dynamic RAM (SDRAM)), bulk storage memory (e.g., CD-ROM and/or DVD-ROM, hard drives), or the like. System memory 720 may include a non-transitory, computer-readable storage medium that may have program instructions stored thereon that are executable by a computer processor (e.g., one or more of processors 710a-710n) to cause the subject matter and the functional operations described herein. A memory (e.g., system memory 720) may include a single memory device and/or a plurality of memory devices (e.g., distributed memory devices).

I/O interface 750 may be configured to coordinate I/O traffic between processors 710a-710n, system memory 720, network interface 740, I/O devices 760, and/or other peripheral devices. I/O interface 750 may perform protocol, timing, or other data transformations to convert data signals from one component (e.g., system memory 720) into a format suitable for use by another component (e.g., processors 710a-710n). I/O interface 750 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 700, or multiple computer systems 700 configured to host different portions or instances of embodiments. Multiple computer systems 700 may provide for parallel or sequential processing/execution of one or more portions of the techniques described herein.

Those skilled in the art will appreciate that computer system 700 is merely illustrative and is not intended to limit the scope of the techniques described herein. Computer system 700 may include any combination of devices or software that may perform or otherwise provide for the performance of the techniques described herein. For example, computer system 700 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 700 may also be connected to other devices that are not illustrated or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

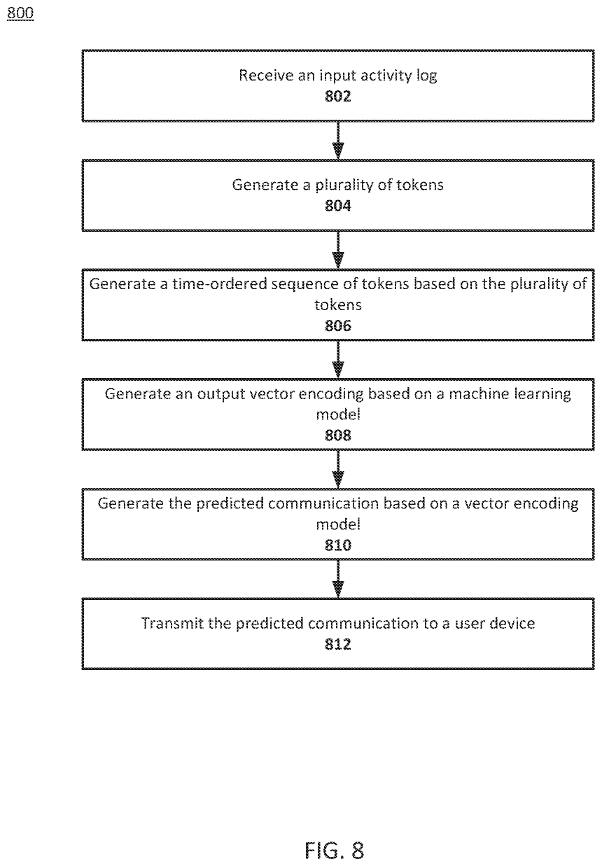

FIG. 8 shows a flowchart of the basic operations involved in predicting account-related user communications based on input activity logs. For example, the system may use process 800 (e.g., as implemented on one or more system components described above) in order to receive activity data related to a user's account and predict a possible user communication indicative of an account status or security breach based on this user activity.

At 802, process 800 (e.g., using one or more components described above) enables computer system 700 to receive an input activity log. For example, computer system 700 may receive, for a user account, an input activity log through network interface 740 and I/O interface 750. For example, the input activity log may be associated with a user account and may include a list of user activities, where each user activity in the list of user activities may correspond to an associated activity timestamp. As an illustrative example, computer system 700 may store the input activity log and associated information within system memory 720 (e.g., within data 780) through I/O interface 750.

At 804, process 800 (e.g., using one or more components described above) enables computer system 700 to generate a plurality of tokens. For example, computer system 700 may utilize one or more processors 710a-710n to generate a plurality of tokens based on a set of criteria, where each token in the plurality of tokens may include a corresponding alphanumeric identifier representing a corresponding activity class for a corresponding user activity of the list of user activities. Processors 710a-710n may determine each corresponding alphanumeric identifier based on one or more activity class rules (e.g., stored within system memory 720 as data 780), where the one or more activity class rules may indicate rules for classifying user activities into corresponding activity classes. Computer system 700 may utilize program instructions 770 to generate these tokens and may store these tokens within data 780.

At 806, process 800 (e.g., using one or more components described above) enables computer system 700 to generate a time-ordered sequence of tokens based on the plurality of tokens stored in data 780. For example, one or more processors 710a-710n may generate a time-ordered sequence of tokens based on the plurality of tokens, where I/O interface 750 may store each token in the time-ordered sequence of tokens in order based on the corresponding activity timestamp associated with the corresponding user activity for each token (e.g., as stored within system memory 720). Computer system 700 may store this time-ordered sequence of tokens within data 780.

At 808, process 800 (e.g., using one or more components described above) enables computer system 700 to utilize processors 710a-710n to generate an output vector encoding based on a machine learning model. For example, computer system 700 may generate an output vector encoding based on inputting the time-ordered sequence of tokens (e.g., as stored in data 780) into a machine learning model. The output vector encoding may represent syntax and lexicon for a predicted communication based on the input activity log. The machine learning model (e.g., its parameters and/or algorithm) may be stored in system memory 720. For example, program instructions 770 may enable the machine learning model to generate representations of predicted communications using program instructions 770, while model weights and other parameters may be stored within data 780.

At 810, process 800 (e.g., using one or more components described above) enables computer system 700 to generate the predicted communication based on a vector encoding model. For example, based on inputting the output vector encoding into a vector encoding model, processors 710a-710n may generate the predicted communication and store this communication within system memory 720, such as within data 780 using I/O interface 750. For example, the vector encoding model may be configured using program instructions 770, while any model weights or corpus of data (e.g., corpus of words associated with natural language processing) may be stored within data 780.

At 812, process 800 (e.g., using one or more components described above) enables computer system 700 to transmit the predicted communication to a user device. For example, I/O device interface 730 may receive the predicted communication through I/O interface 750 from system memory 720 and output the predicted communication on one or more I/O devices 760 for display or transmission to a user interface. Additionally or alternatively, network interface 740 may send a representation of the predicted communication to a network, thereby enabling network-connected user devices to receive the predicted communication.

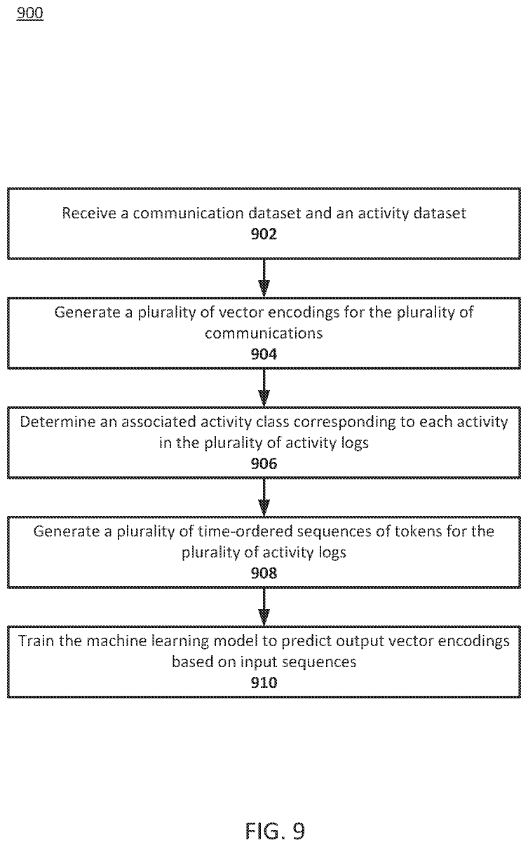

FIG. 9 shows a flowchart of the operations involved in training a machine learning model to predict account-related user communications based on input activity logs. For example, the system may use process 900 (e.g., as implemented on one or more system components described above) to train a machine learning model to output warnings for account-related security breaches based on activity data related to user accounts and corresponding communications.

At 902, process 900 (e.g., using one or more components described above) enables computer system 700 to receive a communication dataset and an activity dataset. For example, network interface 740 may receive a communication dataset and an activity dataset from a network. The communication dataset may include a plurality of communications with each communication related to a corresponding user. The activity dataset may include a plurality of activity logs, wherein each communication is temporally related to a corresponding activity log. The communication and activity datasets may be stored within system memory 720 (e.g., as data 780) through I/O interface 750.

At 904, process 900 (e.g., using one or more components described above) enables computer system 700 to generate a plurality of vector encodings for the plurality of communications. For example, using the vector encoding model, processors 710a-710n may generate vector encodings based on communications within the communication dataset stored within data 780. The plurality of vector encodings may represent natural language of communications in a vector space. The vector encoding model may be associated with program instructions 770. The plurality of vector encodings may be stored within system memory 720 through I/O interface 750.

At 906, process 900 (e.g., using one or more components described above) enables computer system 700 to determine an associated activity class corresponding to each activity in the plurality of activity logs. For example, processors 710a-710n may utilize criteria of a set of criteria stored within system memory 720 to determine associated activity classes corresponding to activities in the plurality of activity logs, where each activity class of the plurality of activity classes classifies activities based on a corresponding criteria of the set of criteria. Processors 710a-710n, through I/O interface 750, may store such activity classes within a data structure in system memory 720 as data 780.

At 908, process 900 (e.g., using one or more components described above) enables computer system 700 to generate a plurality of time-ordered sequences of tokens for the plurality of activity logs. For example, system memory 720 may store the plurality of activity logs in a data structure within data 780 that preserves order of the activities within the activity log. Processors 710a-710n may generate a plurality of time-ordered sequences of tokens for the plurality of activity logs, where each activity log of the plurality of activity logs has a corresponding time-ordered sequence of tokens. Each activity in the plurality of activity logs has a corresponding token of the time-ordered sequence of tokens. Each token of the time-ordered sequence of tokens may uniquely identify the associated activity class. The time-ordered sequences of tokens may be stored within data 780 in system memory 720 through I/O interface 750. Alternatively, computer system 700 may store such sequences within the network through network interface 740.

At 910, process 900 (e.g., using one or more components described above) enables computer system 700 to train the machine learning model to predict output vector encodings based on input sequences. For example, using the plurality of vector encodings and the plurality of time-ordered sequences stored within system memory 720 and/or on the cloud within the network, processors 710a-710n may train the machine learning model associated with program instructions 770 to predict output vector encodings based on input sequences. The machine learning model may enable generation of predictions of expected communications by users based on corresponding input activity logs (e.g., as received at network interface 740 and/or I/O device interface 730).

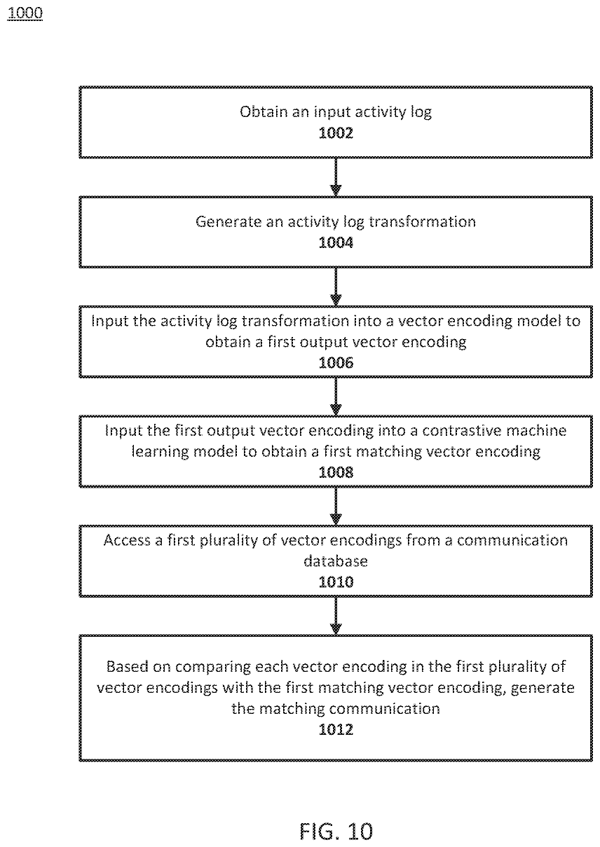

FIG. 10 shows a flowchart of the basic operations involved in associating account-related user communications within input activity logs, or vice versa, using contrastive learning. For example, the system may use process 1000 (e.g., as implemented on one or more system components described above) in order to obtain activity data related to a user's account and predict a relevant user communication indicative of an account status or security breach based on this user activity.

At 1002, process 1000 (e.g., using one or more components described above) enables computer system 700 to obtain an input activity log. For example, network interface 740 may obtain an input activity log through the network, where the input activity log includes a plurality of user activities. For example, computer system 700 may store the input activity log in system memory 720 through I/O interface 750.

At 1004, process 1000 (e.g., using one or more components described above) enables computer system 700 to generate an activity log transformation. For example, processors 710a-710n may retrieve the input activity log from data 780 within system memory 720 and generate, based on the input activity log, an activity log transformation. The activity log transformation may represent the input activity log in a first data format. The activity log transformation may preserve temporal order of activities. For example, computer system 700 may store the activity log transformation in a data structure within system memory 720 (e.g., as data 780) through I/O interface 750.

At 1006, process 1000 (e.g., using one or more components described above) enables computer system 700 to input the activity log transformation into a vector encoding model to obtain a first output vector encoding. For example, processors 710a-710n may utilize program instructions 770 to input the activity log transformation stored within data 780 into a vector encoding model to obtain a first output vector encoding. The first output vector encoding may represent the input activity log in a vector space of the vector encoding model. Processors 710a-710n may store the first output vector encoding within an array or another data structure within system memory 720 through I/O interface 750.

At 1008, process 1000 (e.g., using one or more components described above) enables computer system 700 to input the first output vector encoding into a contrastive learning model (e.g., a contrastive machine learning model) to obtain a first matching vector encoding. For example, processors 710a-710n may utilize program instructions 770 to input the output vector encoding stored within data 780 into a contrastive learning model. The contrastive machine learning model may be associated with program instructions 770, with parameters and/or model weights stored within system memory 720. For example, the first matching vector encoding may represent a first corresponding vector encoding for a matching communication of a communication dataset. The contrastive machine learning model may have been trained on vector encodings within the vector space (e.g., vector encodings stored within system memory 720). Computer system 700 may store the output vector encoding within system memory 720 (e.g., as data 780).

At 1010, process 1000 (e.g., using one or more components described above) enables computer system 700 to access a first plurality of vector encodings from a communication database (e.g., a database associated with the network accessible through network interface 740). For example, network interface 740 may access a first plurality of vector encodings from a communication database, where each vector encoding of the first plurality of vector encodings represents a corresponding communication of a plurality of communications in the vector space of the vector encoding model. For example, computer system 700 may store the first plurality of vector encodings within system memory 720.

At 1012, process 1000 (e.g., using one or more components described above) enables computer system 700 to generate the matching communication based on comparing each vector encoding in the first plurality of vector encodings with the first matching vector encoding. For example, processors 710a-710n, using program instructions 770, may generate, for display on a user interface, the matching communication, based on comparing each vector encoding in the first plurality of vector encodings with the first matching vector encoding. Processors 710a-710n may output a message that includes the matching communication to I/O interface 750, which may enable I/O device(s) 760 to display the message through I/O device interface 730. Alternatively or additionally, computer system 700 may output the matching communication through network interface 740 to a network, to which a user interface or device may be connected.

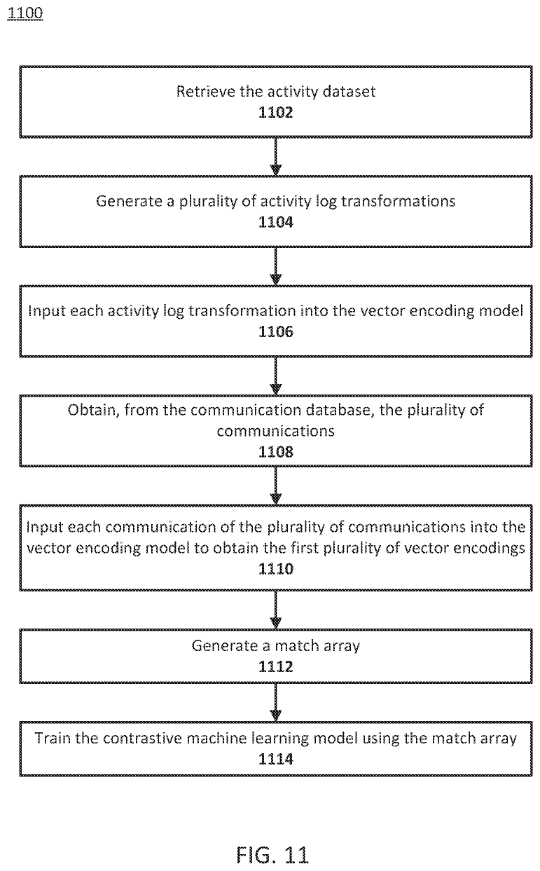

FIG. 11 shows a flowchart of the basic operations involved in training a machine learning model to predict account-related user communications based on input activity logs. For example, the system may use process 1100 (e.g., as implemented on one or more system components described above) to train a machine learning model to output relevant communications for account-related security breaches based on activity data related to user accounts and corresponding communications.

At 1102, process 1100 (e.g., using one or more components described above) enables computer system 700 to retrieve the activity dataset, such as through a network using network interface 740. For example, the activity dataset may include a plurality of activity logs, where each activity log is associated with a corresponding plurality of activities with associated timestamps. Computer system 700 may store the activity dataset within system memory 720 (e.g., as data 780).

At 1104, process 1100 (e.g., using one or more components described above) enables computer system 700 to generate a plurality of activity log transformations. For example, processors 710a-710n may generate a plurality of activity log transformations, where each activity log transformation of the plurality of activity log transformations represents a corresponding activity log of the plurality of activity logs in the first data format and preserves the order of activities based on the associated timestamps. Processors 710a-710n may utilize program instructions 770 to generate the activity log transformations and store these within system memory 720 (e.g., within data 780).

At 1106, process 1100 (e.g., using one or more components described above) enables computer system 700 to input each activity log transformation into the vector encoding model. For example, processors 710a-710n may input each activity log transformation stored within data 780 into a vector encoding model whose instructions are stored within program instructions 770. For example, the vector encoding model may enable computer system 700 to obtain a second plurality of vector encodings for the activity dataset, where each vector encoding of the second plurality of vector encodings represents the corresponding activity log of the plurality of activity logs in the vector space. For example, processors 710a-710n may store the generated plurality of vector encodings within system memory 720 through I/O interface 750.

At 1108, process 1100 (e.g., using one or more components described above) enables computer system 700 to obtain, from the communication database, the plurality of communications. For example, network interface 740 may obtain, from a communication database stored within the network, the plurality of communications. Network interface 740 may transmit the communications to I/O interface 750 for subsequent storage within system memory 720 (e.g., as data 780).

At 1110, process 1100 (e.g., using one or more components described above) enables computer system 700 to obtain the first plurality of vector encodings. For example, I/O interface 750 may input each activity log transformation of the plurality of activity log transformations into the vector encoding model through processors 710a-710n to obtain a second plurality of vector encodings for the activity dataset. Computer system 700 may store the second plurality of vector encodings for the activity dataset within system memory 720 through I/O interface 750. Each vector encoding of the second plurality of vector encodings may represent the corresponding activity log of the plurality of activity logs in the vector space.

At 1112, process 1100 (e.g., using one or more components described above) enables computer system 700 to generate a match array. For example, processors 710a-710n may generate a match array and store the match array within system memory 720 (e.g., as data 780) through I/O interface 750. The match array may include indicators of whether each communication of the communication dataset matches each activity log of the plurality of activity logs. Computer system 700 may store the match array (e.g., a data structure of the form of a two-dimensional array) within system memory 720, within data 780.

At 1114, process 1100 (e.g., using one or more components described above) enables computer system 700 to train the contrastive machine learning model using the match array. For example, processors 710a-710n may train a contrastive machine learning model defined by program instructions 770 (e.g., with model weights or parameters stored as data 780) to enable matching activity logs with user communications. For example, processors 710a-710n may transmit updated model parameters for the contrastive machine learning model to system memory 720 through I/O interface 750 to update any parameters stored in data 780.

It is contemplated that the steps or descriptions of FIGS. 8-11 may be used with any other embodiment of this disclosure. In addition, the steps and descriptions described in relation to FIGS. 8-11 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIGS. 8-11.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
A1. A method, the method comprising: receiving a communication dataset and a user activity dataset, wherein the communication dataset comprises a plurality of communications with each communication related to a user describing an event associated with a corresponding account, wherein the user activity dataset comprises a plurality of activity logs with each activity log associated with the corresponding account, and wherein each communication is temporally related to a corresponding activity log; using a vector encoding model, generating a plurality of vector encodings for the plurality of communications, wherein the plurality of vector encodings comprises vector encodings that represent syntax and lexicon for the plurality of communications; determining an associated activity class of a plurality of activity classes for each activity in the plurality of activity logs, wherein the associated activity class of the plurality of activity classes classifies activities based on a set of criteria; generating a plurality of time-ordered sequences for the plurality of activity logs, wherein each activity log of the plurality of activity logs has a corresponding time-ordered sequence of tokens, wherein each activity of each activity log corresponds to a token of the corresponding time-ordered sequence of tokens, and wherein each token corresponding to each activity of each activity log comprises a corresponding alphanumeric identifier uniquely identifying the associated activity class; and using the plurality of vector encodings and the plurality of time-ordered sequences, training a machine learning model to predict output vector encodings based on input sequences, wherein the machine learning model generates predictions of expected communications by users based on corresponding input activity logs.
A2. A method, the method comprising: receiving, for a user account, an input activity log comprising a list of user activities, wherein each user activity in the list of user activities has a corresponding activity timestamp; generating a plurality of tokens based on a set of criteria, wherein each token in the plurality of tokens comprises a corresponding alphanumeric identifier that represents a corresponding activity class for a corresponding user activity of the list of user activities, wherein each corresponding alphanumeric identifier is determined based on one or more activity class rules, and wherein the one or more activity class rules indicate rules for classifying user activities into corresponding activity classes; based on the plurality of tokens, generating a time-ordered sequence of tokens, wherein each token in the time-ordered sequence of tokens is ordered based on the corresponding activity timestamp associated with the corresponding user activity for each token; based on inputting the time-ordered sequence of tokens into a machine learning model, generating an output vector encoding, wherein the output vector encoding represents syntax and lexicon for a predicted communication based on the input activity log; based on inputting the output vector encoding into a vector encoding model, generating the predicted communication; and transmitting the predicted communication to a user device.
A3. A method, the method comprising: receiving, for a user account, an input activity log comprising a list of user activities, wherein each user activity in the list of user activities has a corresponding activity timestamp; generating a plurality of tokens based on a set of criteria, wherein each token in the plurality of tokens comprises a corresponding alphanumeric identifier that represents a corresponding activity class for a corresponding user activity of the list of user activities, wherein each corresponding alphanumeric identifier is determined based on one or more activity class rules, and wherein the one or more activity class rules indicate rules for classifying user activities into corresponding activity classes; based on the plurality of tokens, generating a time-ordered sequence of tokens, wherein each token in the time-ordered sequence of tokens is ordered based on the corresponding activity timestamp associated with the corresponding user activity for each token; based on inputting the time-ordered sequence of tokens into a machine learning model, generating an output vector encoding, wherein the output vector encoding represents syntax and lexicon for a predicted communication based on the input activity log; based on inputting the output vector encoding into a vector encoding model, generating the predicted communication; and based on the predicted communication, transmitting a recommendation for a system action responsive to the input activity log to a user device.
A4. The method of any one of the preceding embodiments, further comprising: receiving an input activity log, wherein the input activity log is associated with a user account and comprises a list of user activities, and wherein each user activity in the list of user activities corresponds to an associated activity timestamp; generating a plurality of tokens based on user activities within the list of user activities, wherein each token comprises the corresponding alphanumeric identifier of an activity class classifying a corresponding user activity based on the set of criteria; based on the plurality of tokens, generating a time-ordered sequence of tokens, wherein each token in the time-ordered sequence of tokens is ordered based on an activity timestamp associated with a user activity corresponding to each token; based on inputting the time-ordered sequence of tokens into the machine learning model, generating an output vector encoding, wherein the output vector encoding represents syntax and lexicon for a predicted communication based on the input activity log; based on inputting the output vector encoding into the vector encoding model, generating the predicted communication; and based on the predicted communication, generating a recommendation for a system action responsive to the input activity log.
A5. The method of any one of the preceding embodiments, further comprising: receiving a communication dataset and an activity dataset, wherein the communication dataset comprises a plurality of communications with each communication related to a corresponding user, wherein the activity dataset comprises a plurality of activity logs, and wherein each communication is temporally related to a corresponding activity log; using the vector encoding model, generating a plurality of vector encodings for the plurality of communications, wherein the plurality of vector encodings represents natural language of communications in a vector space; determining an associated activity class, of a plurality of activity classes, corresponding to each activity in the plurality of activity logs, wherein each activity class of the plurality of activity classes classifies activities based on a corresponding criteria of the set of criteria; generating a plurality of time-ordered sequences of tokens for the plurality of activity logs, wherein each activity log of the plurality of activity logs has a corresponding time-ordered sequence of tokens, wherein each activity in the plurality of activity logs has a corresponding token of the time-ordered sequence of tokens, and wherein each token of the time-ordered sequence of tokens uniquely identifies the associated activity class; and using the plurality of vector encodings and the plurality of time-ordered sequences, training the machine learning model to predict output vector encodings based on input sequences, wherein the machine learning model enables generation of predictions of expected communications by users based on corresponding input activity logs.
A6. The method of any one of the preceding embodiments, wherein the instructions cause operations further comprising: receiving a communication dataset and an activity dataset, wherein the communication dataset comprises a plurality of communications with each communication related to a corresponding user, wherein the activity dataset comprises a plurality of activity logs, and wherein each communication is temporally related to a corresponding activity log; using the vector encoding model, generating a plurality of vector encodings for the plurality of communications, wherein the plurality of vector encodings represents syntax and lexicon in a vector space; determining an associated activity class, of a plurality of activity classes, corresponding to each activity in the plurality of activity logs, wherein each activity class of the plurality of activity classes classifies activities based on a corresponding criteria of the set of criteria; generating a plurality of time-ordered sequences of tokens for the plurality of activity logs, wherein each activity log of the plurality of activity logs has a corresponding time-ordered sequence of tokens, wherein each activity in the plurality of activity logs has a corresponding token of the time-ordered sequence of tokens, and wherein each token of the time-ordered sequence of tokens uniquely identifies the associated activity class; and using the plurality of vector encodings and the plurality of time-ordered sequences, training the machine learning model to predict output vector encodings based on input sequences, wherein the machine learning model enables generation of predictions of expected communications by users based on corresponding input activity logs.
A7. The method of any one of the preceding embodiments, wherein generating the plurality of time-ordered sequences of tokens for the plurality of activity logs comprises: retrieving a first communication from the plurality of communications; based on first metadata corresponding to the first communication, identifying a corresponding user identifier and a corresponding communication timestamp; based on the corresponding user identifier and the corresponding communication timestamp corresponding to the first communication, retrieving a first activity log; and based on the first activity log, generating a first time-ordered sequence of tokens for the plurality of time-ordered sequences.
A8. The method of any one of the preceding embodiments, further comprising: generating, using the vector encoding model, a first vector encoding for the first communication, wherein the first vector encoding represents natural language of the first communication in the vector space; based on inputting the first time-ordered sequence of tokens into the machine learning model, generating a seed vector encoding, wherein the seed vector encoding represents syntax and lexicon for a seed communication based on the first activity log; based on inputting the seed vector encoding into the machine learning model, generating a resulting sequence of tokens, wherein the resulting sequence of tokens represents a predicted activity log based on the seed communication; and generating training data for training the machine learning model to predict the output vector encodings based on the input sequences, wherein the training data comprises the first vector encoding and the resulting sequence of tokens.
A9. The method of any one of the preceding embodiments, wherein determining the associated activity class, of the plurality of activity classes, corresponding to each activity in the plurality of activity logs comprises: retrieving, from the activity dataset, a first activity log corresponding to a first user account, wherein the first activity log comprises a first plurality of user activities and a corresponding plurality of activity timestamps; determining, based on the set of criteria, the associated activity class for each activity within the first activity log; and based on determining the associated activity class for each activity within the first activity log, generating a set of time-ordered activity classes corresponding to the first activity log.
A10. The method of any one of the preceding embodiments, further comprising: generating a set of tokens corresponding to the set of time-ordered activity classes, wherein each token of the set of tokens comprises an associated alphanumeric identifier representing each activity class of the set of time-ordered activity classes; and based on the set of tokens corresponding to the set of time-ordered activity classes, generating the corresponding time-ordered sequence of tokens for the first activity log using the corresponding plurality of activity timestamps.
A11. The method of any one of the preceding embodiments, wherein generating the plurality of vector encodings for the plurality of communications comprises generating, based on a first communication of the plurality of communications, a plurality of natural language units, wherein each natural language unit of the plurality of natural language units represents any one of a word, a phrase, or a sentence.
A12. The method of any one of the preceding embodiments, further comprising: based on the plurality of natural language units, generating an array of natural language tokens, wherein each natural language token of the array of natural language tokens comprises a corresponding numeric representation of each natural language unit of the plurality of natural language units; and based on inputting the array of natural language tokens into the vector encoding model, generating the plurality of vector encodings for the plurality of communications.
A13. The method of any one of the preceding embodiments, further comprising: determining that a first communication of the communication dataset comprises a first telephonic communication, wherein the first telephonic communication comprises audio data of a conversation between two users; based on inputting the first telephonic communication into a speech recognition model, generating a first telephonic transcript for the first communication; and generating the plurality of vector encodings to include a first vector encoding of the first telephonic transcript.
A14. The method of any one of the preceding embodiments, further comprising: determining that a first communication of the communication dataset comprises first form data, wherein the first form data comprises information submitted, through an electronic form, by the corresponding user associated with a corresponding user account; based on extracting text from fields associated with the first form data, generating a first array of natural language units, wherein each natural language unit of the first array of natural language units represents any one of a word, a phrase, or a sentence; and based on inputting the first array of natural language units into the vector encoding model, generating the plurality of vector encodings to include a first vector encoding of the first form data.
A15. The method of any one of the preceding embodiments, further comprising: based on the predicted communication, determining a user account status, wherein the user account status indicates a risk level for the user account; and generating a recommendation for a system security action, wherein the recommendation comprises a suggested warning message to a user of the user account based on the user account status.
A16. The method of any one of the preceding embodiments, wherein, based on the predicted communication, determining the user account status comprises: extracting, from a key phrase database, a plurality of key phrases, wherein each key phrase of the plurality of key phrases is associated with an account status indicator, wherein the account status indicator comprises an indication of an explanation of the input activity log; and based on determining that the predicted communication includes a first key phrase of the plurality of key phrases, determining a first account status indicator for the user account status.
A17. The method of any one of the preceding embodiments, wherein generating the recommendation for the system security action comprises: based on comparing the user account status with account management rules in an account management ruleset, determining a first account management rule corresponding to the user account status, wherein the account management ruleset comprises a plurality of rules for suggesting account actions based on account statuses; and generating the recommendation for the system security action to include a description of the first account management rule.
A18. The method of any one of the preceding embodiments, wherein generating the plurality of tokens based on the set of criteria comprises: extracting, from a user activity dataset, user activity metadata corresponding to each user activity of the list of user activities; based on comparing the user activity metadata with each criteria of the set of criteria, determining the corresponding activity class for each user activity of the list of user activities; and generating the corresponding alphanumeric identifier for each user activity of the list of user activities, wherein the corresponding alphanumeric identifier for each user activity of the list of user activities uniquely identifies the corresponding activity class for each user activity of the list of user activities.
A19. The method of any one of the preceding embodiments, wherein generating the corresponding alphanumeric identifier for each user activity of the list of user activities comprises: extracting, from first user activity metadata corresponding to a first user activity of the list of user activities, a first resource type associated with the first user activity, wherein the first resource type indicates a classification of a first resource associated with the user account; extracting, from the first user activity metadata, a first resource size associated with the first user activity, wherein the first resource size indicates classification of a size of the first resource; and determining a first alphanumeric identifier for the first user activity, wherein the first alphanumeric identifier identifies an activity class corresponding to the first resource type and the first resource size. A20. One or more tangible, non-transitory, computer-readable media storing instructions that, when executed by a data processing apparatus, cause the data processing apparatus to perform operations comprising those of any of embodiments A1-A19.
A22. A system comprising one or more processors; and memory storing instructions that, when executed by the processors, cause the processors to effectuate operations comprising those of any of embodiments A1-A19.
A23. A system comprising means for performing any of embodiments A1-A19.
B1. A method, the method comprising: receiving an activity dataset and a communication dataset, wherein the activity dataset comprises a plurality of activity logs, and wherein each activity log comprises, for a corresponding user, a corresponding plurality of activities with associated timestamps, and wherein the communication dataset comprises textual representations of communications associated with the plurality of activity logs; generating a plurality of text representations, wherein each text representation of the plurality of text representations comprises a set of text strings ordered by the associated timestamps, and wherein each text representation represents the corresponding plurality of activities of a corresponding activity log of the plurality of activity logs; inputting each text representation of the plurality of text representations into a vector encoding model to obtain a first plurality of vector encodings for the activity dataset, wherein each vector encoding of the first plurality of vector encodings represents the corresponding activity log of the plurality of activity logs in a vector space of the vector encoding model; inputting each communication of the communication dataset into the vector encoding model to obtain a second plurality of vector encodings for the communication dataset, wherein each vector encoding of the second plurality of vector encodings represents text of a corresponding communication in the vector space of the vector encoding model; generating a match array, wherein the match array comprises indicators of whether each communication of the communication dataset matches each activity log of the plurality of activity logs; and training, using the match array, a contrastive machine learning model to generate a new vector encoding that represents an activity log or a user communication in the vector space to enable matching activity logs with user communications.
B2. A method, the method comprising: obtaining an input activity log, wherein the input activity log comprises a plurality of user activities; generating, based on the input activity log, an activity log transformation, wherein the activity log transformation represents the input activity log in a first data format, and wherein the activity log transformation preserves temporal order of activities; inputting the activity log transformation into a vector encoding model to obtain a first output vector encoding, wherein the first output vector encoding represents the input activity log in a vector space of the vector encoding model; inputting the first output vector encoding into a contrastive machine learning model to obtain a first matching vector encoding in the vector space, wherein the first matching vector encoding represents a first corresponding vector encoding for a matching communication of a communication dataset, and wherein the contrastive machine learning model has been trained based on vector encodings within the vector space; accessing a first plurality of vector encodings from a communication database, wherein each vector encoding of the first plurality of vector encodings represents a corresponding communication of a plurality of communications in the vector space of the vector encoding model; and based on comparing each vector encoding in the first plurality of vector encodings with the first matching vector encoding, generating, for display on a user interface, the matching communication.
B3. A method, the method comprising: obtaining an input activity log, wherein the input activity log comprises a plurality of user activities; generating, based on the input activity log, an activity log transformation, wherein the activity log transformation represents the input activity log in a textual data format, and wherein the activity log transformation preserves temporal order of activities; inputting the activity log transformation into a vector encoding model to obtain a first output vector encoding, wherein the first output vector encoding represents the input activity log in a vector space of the vector encoding model; inputting the first output vector encoding into a contrastive machine learning model to obtain a first matching vector encoding, wherein the first matching vector encoding represents a first corresponding vector encoding within the vector space of the vector encoding model for a matching communication of a communication dataset; accessing a first plurality of vector encodings from a communication database, wherein each vector encoding of the first plurality of vector encodings represents a corresponding communication of a plurality of communications in the vector space of the vector encoding model; and based on comparing each vector encoding in the first plurality of vector encodings with the first matching vector encoding, generating, for display on a user interface, the matching communication.
B4. The method of any one of the preceding embodiments, comprising: receiving an input activity log, wherein the input activity log is associated with a user account and comprises a plurality of user activities, and wherein the plurality of user activities has a corresponding plurality of timestamps; generating, based on the input activity log, a user text representation, wherein the user text representation represents the input activity log and comprises a set of user text strings representing the plurality of user activities of the input activity log, and wherein the set of user text strings is in order of the corresponding plurality of timestamps; generating, by inputting the user text representation into the vector encoding model, a first output vector encoding, wherein the first output vector encoding represents the input activity log in the vector space; inputting the first output vector encoding into the contrastive machine learning model to obtain a matching vector encoding, wherein the matching vector encoding represents a corresponding vector encoding corresponding to a matching communication of the communication dataset; extracting, from a communication database, the second plurality of vector encodings; based on comparing each vector encoding in the second plurality of vector encodings with the matching vector encoding, generating the matching communication; and based on the matching communication, generating a prediction for a security-related user event corresponding to the user account.
B5. The method of any one of the preceding embodiments, further comprising: retrieving an activity dataset, wherein the activity dataset comprises a plurality of activity logs, and wherein each activity log is associated with a corresponding plurality of activities with associated timestamps; generating a plurality of activity log transformations, wherein each activity log transformation of the plurality of activity log transformations represents a corresponding activity log of the plurality of activity logs in the first data format and preserves the order of activities based on the associated timestamps; inputting each activity log transformation of the plurality of activity log transformations into the vector encoding model to obtain a second plurality of vector encodings for the activity dataset, wherein each vector encoding of the second plurality of vector encodings represents the corresponding activity log of the plurality of activity logs in the vector space; obtaining, from the communication database, the plurality of communications; inputting each communication of the plurality of communications into the vector encoding model to obtain the first plurality of vector encodings, wherein each vector encoding of the first plurality of vector encodings represents the corresponding communication of the plurality of communications in the vector space of the vector encoding model; generating a match array, wherein the match array comprises indicators of whether each communication of the communication dataset matches each activity log of the plurality of activity logs; and training, using the match array, the contrastive machine learning model to enable matching activity logs with user communications.
B6. The method of any one of the preceding embodiments, wherein generating the match array comprises: determining, using the communication database, a first user identifier for a first communication in the plurality of communications; determining, using the activity dataset, a second user identifier for a first activity log in the plurality of activity logs; based on comparing the first user identifier and the second user identifier, generating an indication of a match; and generating the match array to include the indication of the match within an element of the match array that corresponds to the first communication and the first activity log.
B7. The method of any one of the preceding embodiments, wherein generating the match array comprises: generating a first list of indices, wherein each index of the first list of indices labels the corresponding activity log of the plurality of activity logs; generating a second list of indices, wherein each index of the second list of indices labels the corresponding communication of the plurality of communications; and generating, as the match array, a match matrix comprising a plurality of elements, wherein each element of the plurality of elements is associated with a corresponding first index of the first list of indices and a corresponding second index of the second list of indices, and wherein each element of the plurality of elements indicates that the corresponding activity log of the corresponding first index matches the corresponding communication of the corresponding second index.
B8. The method of any one of the preceding embodiments, wherein training, using the match array, the contrastive machine learning model to enable matching the activity logs with the user communications comprises: determining a first vector encoding from the first plurality of vector encodings and a second vector encoding from the second plurality of vector encodings; determining, using the match array, a token indicating whether a first communication represented by the first vector encoding matches a first activity log represented by the second vector encoding; based on the token indicating a match, generating, within a training dataset, input data comprising the first vector encoding and target data comprising the second vector encoding; and based on the input data and the target data, training the contrastive machine learning model to output a new vector encoding that represents an activity log or a user communication in the vector space to enable matching the activity logs with the user communications.
B9. The method of any one of the preceding embodiments, wherein training, using the match array, the contrastive machine learning model to enable matching the activity logs with the user communications comprises: determining a first vector encoding from the first plurality of vector encodings and a second vector encoding from the second plurality of vector encodings; determining, using the match array, a numerical value indicating whether a first communication represented by the first vector encoding matches a first activity log represented by the second vector encoding; generating, within a training dataset, input data and target data, wherein the input data comprises the first vector encoding and the second vector encoding, and wherein the target data comprises the numerical value; and training the contrastive machine learning model using the training dataset to output a similarity metric between an encoded communication and an encoded activity log.
B10. The method of any one of the preceding embodiments, wherein obtaining, from the communication database, the plurality of communications comprises: receiving, from the communication database, a plurality of voice communications, wherein the plurality of voice communications comprises audio files including human speech; using a speech-to-text model, generating a plurality of textual representations, wherein each textual representation of the plurality of textual representations comprises a corresponding text string representing a corresponding voice communication of the plurality of voice communications; and storing the plurality of textual representations as the plurality of communications.
B11. The method of any one of the preceding embodiments, further comprising: receiving an input communication; generating, based on the input communication, a communication transformation, wherein the communication transformation represents the input communication in the first data format; inputting the input communication into the vector encoding model to obtain a second output vector encoding, wherein the second output vector encoding represents the input communication in the vector space of the vector encoding model; inputting the second output vector encoding into the contrastive machine learning model to obtain a second matching vector encoding, wherein the second matching vector encoding represents a second corresponding vector encoding within the vector space of the vector encoding model for a matching activity log of the activity dataset; accessing the second plurality of vector encodings from an activity database; and based on comparing each vector encoding in the second plurality of vector encodings with the second matching vector encoding, generating, for display the matching activity log on the user interface.
B12. The method of any one of the preceding embodiments, wherein comparing each vector encoding in the first plurality of vector encodings with the first matching vector encoding comprises: determining a vector similarity metric, wherein the vector similarity metric indicates similarity between a first vector encoding of the first plurality of vector encodings and the first matching vector encoding; determining, based on the vector similarity metric, that the first vector encoding matches the first matching vector encoding; and based on determining that the first vector encoding matches the first matching vector encoding, generating, for display on the user interface, the matching communication, wherein the matching communication corresponds to the first vector encoding.
B13. The method of any one of the preceding embodiments, further comprising: receiving, from a user device associated with the input activity log, a first search query comprising a first text string; generating, based on the matching communication, a second text string associated with the input activity log; generating a second search query comprising the first text string and the second text string; transmitting the second search query to a search engine, wherein the search engine provides search results based on the second search query; and causing the user device to display the search results.
B14. The method of any one of the preceding embodiments, wherein, based on comparing each vector encoding in the first plurality of vector encodings with the first matching vector encoding, generating the matching communication comprises: generating a plurality of similarity metrics, wherein each similarity metric of the plurality of similarity metrics indicates a corresponding measure of similarity between a corresponding vector encoding of the first plurality of vector encodings and the first matching vector encoding; based on comparing each similarity metric of the plurality of similarity metrics with other similarity metrics of the plurality of similarity metrics, generating a similar vector encoding; and based on determining that the similar vector encoding corresponds to the first corresponding vector encoding for the matching communication, generating the matching communication.
B15. The method of any one of the preceding embodiments, wherein generating, based on the input activity log, the activity log transformation comprises: generating a plurality of tokens based on a list of user activities within the input activity log, wherein each token of the plurality of tokens comprises a corresponding alphanumeric identifier that represents a corresponding activity class for a corresponding user activity of the list of user activities, and wherein each corresponding alphanumeric identifier is determined based on one or more activity class rules, and wherein the one or more activity class rules indicate rules for classifying user activities into corresponding activity classes; and based on the plurality of tokens, generating, as the activity log transformation, a time-ordered sequence of tokens, wherein each token in the time-ordered sequence of tokens is ordered based on a corresponding activity timestamp associated with the corresponding user activity for each token.
B16. The method of any one of the preceding embodiments, wherein generating, based on the input activity log, the activity log transformation comprises: generating a plurality of tokens based on a list of user activities within the input activity log, wherein each token of the plurality of tokens comprises a corresponding text string that represents a corresponding activity class for a corresponding user activity of the list of user activities, and wherein each corresponding text string is determined based on one or more activity rules, and wherein the one or more activity rules indicate rules for representing user activities using text; and based on the plurality of tokens, generating, as the activity log transformation, a textual representation of the input activity log, wherein the textual representation of the input activity log comprises the plurality of tokens.
B17. The method of any one of the preceding embodiments, wherein generating, based on the input activity log, the activity log transformation comprises: determining, for a first activity of the input activity log, a plurality of fields and a plurality of corresponding values, wherein a corresponding value for each field of the plurality of fields characterizes the first activity; generating a plurality of text labels corresponding to the plurality of fields, wherein each text label of the plurality of text labels comprises a corresponding field text string characterizing a corresponding field of the plurality of fields; based on concatenating each text label of the plurality of text labels with the corresponding field text string, generating a first textual representation of the first activity; and generating the activity log transformation to include the first textual representation of the first activity.
B18. The method of any one of the preceding embodiments, further comprising: based on comparing the matching communication with an entry of the communication database, determining a reference user identifier corresponding to the matching communication; extracting, based on the reference user identifier, from an activity database, a reference activity log corresponding to the matching communication; and generating, based on the reference activity log, a prediction for an account event for a user corresponding to the input activity log.
B19. The method of any one of the preceding embodiments, wherein obtaining the input activity log comprises: receiving a user activity log, wherein the user activity log comprises a plurality of activities, and wherein the plurality of activities has an associated plurality of timestamps; based on comparing each timestamp of the associated plurality of timestamps with a threshold timestamp, determining a subset of the associated plurality of timestamps; and generating the input activity log to include a subset of the plurality of activities, wherein each activity of the subset of the plurality of activities has a corresponding timestamp of the subset of the associated plurality of timestamps.
B20. The method of any one of the preceding embodiments, further comprising: retrieving an activity dataset, wherein the activity dataset comprises a plurality of activity logs, and wherein each activity log is associated with a corresponding plurality of activities with associated timestamps; generating a plurality of activity log transformations, wherein each activity log transformation of the plurality of activity log transformations represents a corresponding activity log of the plurality of activity logs in the textual data format and preserves the order of activities based on the associated timestamps; inputting each activity log transformation of the plurality of activity log transformations into the vector encoding model to obtain a second plurality of vector encodings for the activity dataset, wherein each vector encoding of the second plurality of vector encodings represents the corresponding activity log of the plurality of activity logs in the vector space; obtaining, from the communication database, the plurality of communications; inputting each communication of the plurality of communications into the vector encoding model to obtain the first plurality of vector encodings, wherein each vector encoding of the first plurality of vector encodings represents the corresponding communication of the plurality of communications in the vector space of the vector encoding model; generating a match array, wherein the match array comprises indicators of whether each communication of the communication dataset matches each activity log of the plurality of activity logs; and training, using the match array, the contrastive machine learning model to output vector encodings of activity logs or communications to enable matching activity logs with user communications.
B21. One or more tangible, non-transitory, computer-readable media storing instructions that, when executed by a data processing apparatus, cause the data processing apparatus to perform operations comprising those of any of embodiments B1-B20.
B22. A system comprising one or more processors; and memory storing instructions that, when executed by the processors, cause the processors to effectuate operations comprising those of any of embodiments B1-B20.
B23. A system comprising means for performing any of embodiments B1-B20.

What is claimed is:

1. A system for recommending system security actions for user accounts within data servers, the system comprising:
one or more processors; and
one or more non-transitory, computer-readable media storing instructions that, when executed by the one or more processors, cause operations comprising:
receiving a communication dataset and a user activity dataset, wherein the communication dataset comprises a plurality of communications with each communication related to a user describing an event associated with a corresponding account, wherein the user activity dataset comprises a plurality of activity logs with each activity log associated with the corresponding account, and wherein each communication is temporally related to a corresponding activity log;
using a vector encoding model, generating a plurality of vector encodings for the plurality of communications, wherein the plurality of vector encodings comprises vector encodings that represent syntax and lexicon for the plurality of communications;
determining an associated activity class of a plurality of activity classes for each activity in the plurality of activity logs, wherein the associated activity class of the plurality of activity classes classifies activities based on a set of criteria;
generating a plurality of time-ordered sequences for the plurality of activity logs, wherein each activity log of the plurality of activity logs has a corresponding time-ordered sequence of tokens, wherein each activity of each activity log corresponds to a token of the corresponding time-ordered sequence of tokens, and wherein each token corresponding to each activity of each activity log comprises a corresponding alphanumeric identifier uniquely identifying the associated activity class; and
using the plurality of vector encodings and the plurality of time-ordered sequences, training a machine learning model to predict output vector encodings based on input sequences, wherein the machine learning model generates predictions of expected communications by users based on corresponding input activity logs.

2. The system of claim 1, wherein the instructions, when executed by the one or more processors, cause operations further comprising:
receiving an input activity log, wherein the input activity log is associated with a user account and comprises a list of user activities, and wherein each user activity in the list of user activities corresponds to an associated activity timestamp;
generating a plurality of tokens based on user activities within the list of user activities, wherein each token comprises the corresponding alphanumeric identifier of an activity class classifying a corresponding user activity based on the set of criteria;
based on the plurality of tokens, generating a time-ordered sequence of tokens, wherein each token in the time-ordered sequence of tokens is ordered based on an activity timestamp associated with a user activity corresponding to each token;
based on inputting the time-ordered sequence of tokens into the machine learning model, generating an output vector encoding, wherein the output vector encoding represents syntax and lexicon for a predicted communication based on the input activity log;
based on inputting the output vector encoding into the vector encoding model, generating the predicted communication; and
based on the predicted communication, generating a recommendation for a system action responsive to the input activity log.

3. A method for recommending system security actions for user accounts within data servers, the method comprising:
receiving, for a user account, an input activity log comprising a list of user activities, wherein each user activity in the list of user activities has a corresponding activity timestamp;
generating a plurality of tokens based on a set of criteria, wherein each token in the plurality of tokens comprises a corresponding alphanumeric identifier that represents a corresponding activity class for a corresponding user activity of the list of user activities, wherein each corresponding alphanumeric identifier is determined based on one or more activity class rules, and wherein the one or more activity class rules indicate rules for classifying user activities into corresponding activity classes;
based on the plurality of tokens, generating a time-ordered sequence of tokens, wherein each token in the time-ordered sequence of tokens is ordered based on the corresponding activity timestamp associated with the corresponding user activity for each token;
based on inputting the time-ordered sequence of tokens into a machine learning model, generating an output vector encoding, wherein the output vector encoding represents syntax and lexicon for a predicted communication based on the input activity log;
based on inputting the output vector encoding into a vector encoding model, generating the predicted communication; and
transmitting the predicted communication to a user device.

4. The method of claim 3, further comprising:
receiving a communication dataset and an activity dataset, wherein the communication dataset comprises a plurality of communications with each communication related to a corresponding user, wherein the activity dataset comprises a plurality of activity logs, and wherein each communication is temporally related to a corresponding activity log;
using the vector encoding model, generating a plurality of vector encodings for the plurality of communications, wherein the plurality of vector encodings represents natural language of communications in a vector space;
determining an associated activity class, of a plurality of activity classes, corresponding to each activity in the plurality of activity logs, wherein each activity class of the plurality of activity classes classifies activities based on a corresponding criteria of the set of criteria;
generating a plurality of time-ordered sequences of tokens for the plurality of activity logs, wherein each activity log of the plurality of activity logs has a corresponding time-ordered sequence of tokens, wherein each activity in the plurality of activity logs has a corresponding token of the time-ordered sequence of tokens, and wherein each token of the time-ordered sequence of tokens uniquely identifies the associated activity class; and
using the plurality of vector encodings and the plurality of time-ordered sequences, training the machine learning model to predict output vector encodings based on input sequences, wherein the machine learning model enables generation of predictions of expected communications by users based on corresponding input activity logs.

5. The method of claim 4, wherein generating the plurality of time-ordered sequences of tokens for the plurality of activity logs comprises:
retrieving a first communication from the plurality of communications;
based on first metadata corresponding to the first communication, identifying a corresponding user identifier and a corresponding communication timestamp;
based on the corresponding user identifier and the corresponding communication timestamp corresponding to the first communication, retrieving a first activity log; and
based on the first activity log, generating a first time-ordered sequence of tokens for the plurality of time-ordered sequences.

6. The method of claim 5, further comprising:
generating, using the vector encoding model, a first vector encoding for the first communication, wherein the first vector encoding represents natural language of the first communication in the vector space;
based on inputting the first time-ordered sequence of tokens into the machine learning model, generating a seed vector encoding, wherein the seed vector encoding represents syntax and lexicon for a seed communication based on the first activity log;
based on inputting the seed vector encoding into the machine learning model, generating a resulting sequence of tokens, wherein the resulting sequence of tokens represents a predicted activity log based on the seed communication; and
generating training data for training the machine learning model to predict the output vector encodings based on the input sequences, wherein the training data comprises the first vector encoding and the resulting sequence of tokens.

7. The method of claim 4, wherein determining the associated activity class, of the plurality of activity classes, corresponding to each activity in the plurality of activity logs comprises:
retrieving, from the activity dataset, a first activity log corresponding to a first user account, wherein the first activity log comprises a first plurality of user activities and a corresponding plurality of activity timestamps;
determining, based on the set of criteria, the associated activity class for each activity within the first activity log; and
based on determining the associated activity class for each activity within the first activity log, generating a set of time-ordered activity classes corresponding to the first activity log.

8. The method of claim 7, further comprising:
generating a set of tokens corresponding to the set of time-ordered activity classes, wherein each token of the set of tokens comprises an associated alphanumeric identifier representing each activity class of the set of time-ordered activity classes; and
based on the set of tokens corresponding to the set of time-ordered activity classes, generating the corresponding time-ordered sequence of tokens for the first activity log using the corresponding plurality of activity timestamps.

9. The method of claim 4, wherein generating the plurality of vector encodings for the plurality of communications comprises generating, based on a first communication of the plurality of communications, a plurality of natural language units, wherein each natural language unit of the plurality of natural language units represents any one of a word, a phrase, or a sentence.

10. The method of claim 9, further comprising:
based on the plurality of natural language units, generating an array of natural language tokens, wherein each natural language token of the array of natural language tokens comprises a corresponding numeric representation of each natural language unit of the plurality of natural language units; and
based on inputting the array of natural language tokens into the vector encoding model, generating the plurality of vector encodings for the plurality of communications.

11. The method of claim 4, further comprising:
determining that a first communication of the communication dataset comprises a first telephonic communication, wherein the first telephonic communication comprises audio data of a conversation between two users;
based on inputting the first telephonic communication into a speech recognition model, generating a first telephonic transcript for the first communication; and
generating the plurality of vector encodings to include a first vector encoding of the first telephonic transcript.

12. The method of claim 4, further comprising:
determining that a first communication of the communication dataset comprises first form data, wherein the first form data comprises information submitted, through an electronic form, by the corresponding user associated with a corresponding user account;
based on extracting text from fields associated with the first form data, generating a first array of natural language units, wherein each natural language unit of the first array of natural language units represents any one of a word, a phrase, or a sentence; and
based on inputting the first array of natural language units into the vector encoding model, generating the plurality of vector encodings to include a first vector encoding of the first form data.

13. The method of claim 3, further comprising:
based on the predicted communication, determining a user account status, wherein the user account status indicates a risk level for the user account; and
generating a recommendation for a system security action, wherein the recommendation comprises a suggested warning message to a user of the user account based on the user account status.

14. The method of claim 13, wherein, based on the predicted communication, determining the user account status comprises:
extracting, from a key phrase database, a plurality of key phrases, wherein each key phrase of the plurality of key phrases is associated with an account status indicator, wherein the account status indicator comprises an indication of an explanation of the input activity log; and
based on determining that the predicted communication includes a first key phrase of the plurality of key phrases, determining a first account status indicator for the user account status.

15. The method of claim 13, wherein generating the recommendation for the system security action comprises:
based on comparing the user account status with account management rules in an account management ruleset, determining a first account management rule corresponding to the user account status, wherein the account management ruleset comprises a plurality of rules for suggesting account actions based on account statuses; and
generating the recommendation for the system security action to include a description of the first account management rule.

16. The method of claim 3, wherein generating the plurality of tokens based on the set of criteria comprises:
extracting, from a user activity dataset, user activity metadata corresponding to each user activity of the list of user activities;
based on comparing the user activity metadata with each criteria of the set of criteria, determining the corresponding activity class for each user activity of the list of user activities; and
generating the corresponding alphanumeric identifier for each user activity of the list of user activities, wherein the corresponding alphanumeric identifier for each user activity of the list of user activities uniquely identifies the corresponding activity class for each user activity of the list of user activities.

17. The method of claim 16, wherein generating the corresponding alphanumeric identifier for each user activity of the list of user activities comprises:
extracting, from first user activity metadata corresponding to a first user activity of the list of user activities, a first resource type associated with the first user activity, wherein the first resource type indicates a classification of a first resource associated with the user account;
extracting, from the first user activity metadata, a first resource size associated with the first user activity, wherein the first resource size indicates classification of a size of the first resource; and
determining a first alphanumeric identifier for the first user activity, wherein the first alphanumeric identifier identifies an activity class corresponding to the first resource type and the first resource size.

18. One or more non-transitory, computer-readable media comprising instructions that, when executed by one or more processors, cause operations comprising:
receiving, for a user account, an input activity log comprising a list of user activities, wherein each user activity in the list of user activities has a corresponding activity timestamp;
generating a plurality of tokens based on a set of criteria, wherein each token in the plurality of tokens comprises a corresponding alphanumeric identifier that represents a corresponding activity class for a corresponding user activity of the list of user activities, wherein each corresponding alphanumeric identifier is determined based on one or more activity class rules, and wherein the one or more activity class rules indicate rules for classifying user activities into corresponding activity classes;
based on the plurality of tokens, generating a time-ordered sequence of tokens, wherein each token in the time-ordered sequence of tokens is ordered based on the corresponding activity timestamp associated with the corresponding user activity for each token;
based on inputting the time-ordered sequence of tokens into a machine learning model, generating an output vector encoding, wherein the output vector encoding represents syntax and lexicon for a predicted communication based on the input activity log;
based on inputting the output vector encoding into a vector encoding model, generating the predicted communication; and
based on the predicted communication, transmitting a recommendation for a system action responsive to the input activity log to a user device.

19. The one or more non-transitory, computer-readable media of claim 18, wherein the instructions cause operations further comprising:
receiving a communication dataset and an activity dataset, wherein the communication dataset comprises a plurality of communications with each communication related to a corresponding user, wherein the activity dataset comprises a plurality of activity logs, and wherein each communication is temporally related to a corresponding activity log;
using the vector encoding model, generating a plurality of vector encodings for the plurality of communications, wherein the plurality of vector encodings represents syntax and lexicon in a vector space;
determining an associated activity class, of a plurality of activity classes, corresponding to each activity in the plurality of activity logs, wherein each activity class of the plurality of activity classes classifies activities based on a corresponding criteria of the set of criteria;
generating a plurality of time-ordered sequences of tokens for the plurality of activity logs, wherein each activity log of the plurality of activity logs has a corresponding time-ordered sequence of tokens, wherein each activity in the plurality of activity logs has a corresponding token of the time-ordered sequence of tokens, and wherein each token of the time-ordered sequence of tokens uniquely identifies the associated activity class; and
using the plurality of vector encodings and the plurality of time-ordered sequences, training the machine learning model to predict output vector encodings based on input sequences, wherein the machine learning model enables generation of predictions of expected communications by users based on corresponding input activity logs.

20. The one or more non-transitory, computer-readable media of claim 19, wherein the instructions for generating the plurality of time-ordered sequences of tokens for the plurality of activity logs cause operations comprising:
retrieving a first communication from the plurality of communications;
based on first metadata corresponding to the first communication, identifying a corresponding user identifier and a corresponding communication timestamp;
based on the corresponding user identifier and the corresponding communication timestamp corresponding to the first communication, retrieving a first activity log; and
based on the first activity log, generating a first time-ordered sequence of tokens for the plurality of time-ordered sequences.
